(19) United States
(12) Patent Application Publication
(10) Pub. No.: US 2024/0312116 A1
(43) Pub. Date: Sep. 19, 2024

(54) SYSTEMS AND METHODS FOR RENDERING OF VISUALS AND GRAPHICS

(71) Applicant: University of Washington, Seattle, WA (US)

(72) Inventors: Henning Lange, Seattle, WA (US); Jose Nathan Kutz, Seattle, WA (US)

(21) Appl. No.: 18/331,034

(22) Filed: Jun. 7, 2023

Related U.S. Application Data
(60) Provisional application No. 63/349,880, filed on Jun. 7, 2022.

(51) Int. Cl. G06T 15/06

(52) U.S. Cl. CPC G06T 15/06

(57) ABSTRACT

Embodiments of the present disclosure provide methods of rendering an image. An example method includes: performing a convolution of a kernel function located at each of a plurality of source locations and weighted by input weights; storing, as a result of the convolution, for each voxel in a three dimensional (3D) space, coefficients of a series expansion; calculating line integrals along a ray in the 3D space using the coefficients of the series expansion in voxels along at least a portion of the ray; and rendering the image based, at least in part, on the line integrals.

### CROSS-REFERENCE TO RELATED APPLICATION(S)

This application claims priority to U.S. Provisional Application No. 63/349,880, filed Jun. 7, 2022, which application is hereby incorporated by reference, in its entirety, for any purpose.

### STATEMENT OF FEDERALLY SPONSORED RESEARCH AND DEVELOPMENT

This invention was made with government support under Grant No. FA9550-19-1-0011 awarded by the Air Force Office of Scientific Research. The government has certain rights in the invention.

### BACKGROUND

Fast summation techniques, such as the fast Fourier transform (FFT), has dramatically reduced costs of computations associated with certain operations. The fast convolutional Taylor transform (FCTT), a variant of the Fast Multipole Method (FMM), can be understood by analogy to the FFT. Unlike the FFT, it is based on Taylor series instead of Fourier series, but like the FFT it exploits mathematical properties to reduce the computational complexity of performing a transformation that results in a space with certain advantageous properties. In the case of the FCTT, for example, root finding and integration become much easier to perform in the transformed space.

Regular convolutional layers employed in many neural networks designed for applications in image processing usually assume a discrete and fixed spatial grid. Every grid cell is associated with a weight, and computing the output of the convolutional layer requires convolving the weights distributed over this fixed grid with a kernel.

### BRIEF DESCRIPTION OF THE DRAWINGS

FIG. 1 is a schematic illustration of a system in accordance with examples described herein.

FIG. 2 is a schematic illustration of a flowchart of a method in accordance with examples described herein.

FIG. 3A illustrates inputs as continuous spatial locations and weights in accordance with examples described herein.

FIG. 3B illustrates a series expansion in accordance with examples described herein.

FIG. 3C illustrates outputs in accordance with examples described herein.

FIG. 4 shows an equation representing an approximation using the FMM in accordance with examples described herein.

FIG. 5A shows an equation locally representing an approximation using the FMM in accordance with examples described herein.

FIG. 5B illustrates a Taylor series expansion corresponding to the equation of FIG. 5A in accordance with examples described herein.

FIGS. 6A and 6B are schematic illustrations of implicit layers in accordance with examples described herein.

FIG. 7 shows an equation representing an approximation of near-field and far-filed interactions at spatial location qₘ using the FMM in accordance with examples described herein.

FIG. 8 is a schematic illustration of a flowchart of a method in accordance with examples described herein.

FIG. 9 is a schematic illustration of a system in accordance with examples described herein.

FIGS. 10-20 show mathematical equations and/or approximations representing a process of obtaining fast continuous convolutional Taylor transform (FC2T2) in accordance with examples described herein.

FIGS. 21 and 22 are pseudo codes of the FC2T2 in accordance with examples described herein.

FIGS. 23-25 and 27 show mathematical equations and/or approximations representing a process of obtaining FC2T2 in accordance with examples described herein.

FIGS. 26A and 26B illustrate types of kernels in accordance with examples described herein.

FIG. 28 is a schematic illustration of overview of data flow and operations in accordance with examples described herein.

FIG. 29 is a schematic illustration of effects of a polynomial fitting to a kernel and its partial derivatives in accordance with examples described herein.

FIGS. 30A-31 show performance benchmarks in accordance with examples described herein.

FIGS. 32A-32D show mathematical equations and/or approximations representing a process of obtaining explicit Taylor layer operations in accordance with examples described herein.

FIGS. 33A-33C illustrate visual comparison of results using the explicit Taylor layer operations for signed distance function (SDF) in accordance with examples described herein.

FIG. 34 shows mathematical equations representing parameters in a root-implicit Taylor layer in accordance with examples described herein.

FIGS. 35A and 35B are schematic illustrations of a root-implicit Taylor layer in accordance with examples described herein.

FIGS. 36A-36D show mathematical equations representing a process of root finding in accordance with examples described herein.

FIG. 37 shows a pseudo code representing a process of root finding in accordance with examples described herein.

FIGS. 38A-38C show mathematical equations representing a process of Jacobian Vector Products (JVPs) in accordance with examples described herein.

FIGS. 39A-39E show mathematical equations representing a process of ray length JVP in accordance with examples described herein.

FIGS. 40A-40F show mathematical equations representing a process of surface gradient JVP in accordance with examples described herein.

FIG. 41 shows a schematic illustration of an autoencoder in accordance with examples described herein.

FIG. 42 illustrates visual comparison of results using operations for a depth and color (RGBD) layer in accordance with examples described herein.

FIGS. 43 and 45 show mathematical equations representing a process of a line integral along a ray in accordance with examples described herein.

FIG. 44 shows a pseudo code that computes a line integral along a ray in accordance with examples described herein.

FIGS. 46A and 46B show pseudo codes representing processes of volumetric rendering integral in accordance with examples described herein.

FIGS. 47A-47G show mathematical equations representing a process of line integral JVP in accordance with examples described herein.

FIGS. 48-50E show mathematical equations representing a process of volumetric rendering JVP in accordance with examples described herein.

FIG. 51 illustrates a comparison of computation for the forward and backward pass as a function of the image's resolution in accordance with one embodiment.

FIGS. 52A-52D illustrate visual comparison of training results in accordance with examples described herein.

### DETAILED DESCRIPTION

The following description of certain embodiments is merely exemplary in nature and is in no way intended to limit the scope of the disclosure, the claims that follow, or its applications or uses. In the following detailed description of embodiments of the present methods, reference is made to the accompanying drawings which form a part hereof, and which are shown by way of illustration specific to embodiments in which the described systems and methods may be practiced. It is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense for the appended claims.

Series expansions have been a cornerstone of applied mathematics and engineering for centuries. Popular series expansions that have previously been used are, for example, the Multipole, Chebyshev, or Taylor expansions. Applications in image processing usually assumes a discrete and fixed spatial grid. On the other hand, the FMM performs in continuous space. Every weight is associated with a position in a low-dimensional space and computing the output involves convolving the spatially distributed weights with a kernel. The regular convolutional layer assumes fixed locations of the weights and learns an optimal kernel; however, examples of techniques described herein utilize a fixed kernel and learn optimal spatial locations and weights. Internally, similar to the regular convolutional layer, the FMM computes quantities on a grid. However, instead of storing the function value at every location of the grid, examples of the FMM may store a set of series expansion coefficients that may allow for efficient computation of the value of a function at any location within a grid cell.

Furthermore, based on the FMM, the coefficients of a three dimensional (3D) Taylor series expansion may be stored in every grid cell. The 3D Taylor series expansion may allow for exploitation of function values at specific locations but also allow for direct action on this intermediary representation. The following mathematical properties of the 3D Taylor expansion may be utilized.

Line to polynomial: Any line (or ray) through a 3D Taylor series expansion can be converted to a one dimensional (1D) polynomial efficiently.

Root finding: Given a polynomial of order equal to or smaller than 4, analytical closed-form solutions for its roots exist and are fast to evaluate.

Integration and differentiation: Integrating and differentiating polynomials is trivial and fast. The ability for quickly computing partial derivatives is particularly useful in the context of gradient based learning.

Polynomial closure: If g(x) and f(x) are polynomials, then so are f(x)+g(x), f(x)g(x) and f(g(x)). Adding, multiplying, and composing polynomials is also reasonably fast if the degree of the polynomials is sufficiently small.

Polynomial to 3D Taylor: While the traditional FMM inserts points associated with a weight into the far-field expansion, the strategies introduced in this work allow us to insert functions of lines into the expansion.

In this disclosure, techniques may include series expansions and fast summations from a machine learning perspective. In some embodiments, a convolution of a kernel function at source locations may be performed and coefficients of a series expansion for each voxel in a 3D space may be obtained for reducing computational time. For example, a neural network-based transform method, such as an FC2T2 method, approximates computational operations for gradient based learning, with application in computer graphics rendering. In some embodiments, an approximation technique using FC2T2 reduces computational complexity of N-body problems from O(NM) to O(N+M). For example, once computational complexity for series expansions is considered, computational complexity for obtaining the value of a pixel may be independent from a number of model parameters. As an intermediary operation, a series expansion may be produced for every cell on a grid. These operations may analytically but approximately compute the quantities for the forward and backward pass of a backpropagation and may therefore be employed as (implicit) layers in neural networks.

Examples of methods use the FC2T2 tailored to machine learning in order to approximate outputs and Jacobian Vector Products (JVPs). Unlike the FMM, interactions in the FC2T2 method may be approximated by a series expansion. By approximating interactions by a series expansion, the constant coefficients for evaluation to Cₑᵥₐₗ may be reduced and operations that may act directly on the series expansion may be designed and mathematical properties of the series expansion may be used.

Advantageous mathematical properties of performing a convolution of a kernel function at source locations and obtaining coefficients of a series expansion for each voxel in a 3D space have been exploited to reduce time for training and performing inference in low-dimensional models that are ubiquitous in computer vision and robotics. Because of a different computational complexity class of methods in this disclosure compared to existing technologies, the potential time reduction may correspond to a problem size. Even for relatively small problems, an approach in this disclosure may result in time reduction in floating point operations.

Advantageously, examples of methods described herein may utilize performing a convolution of a kernel function at source locations and obtaining coefficients of a series expansion for each voxel in a 3D space. Examples of rendering images or calculating a physical property in 3D space in a transformed space may be advantageous to obtain data at imaginary locations (e.g., obtaining information about an object from angles not included in angles corresponding to camera positions, in order to render one or images of the object, or calculating a physical property in 3D space) while reducing computation time. Examples of methods described herein may be applied to multi-modal vision (e.g., RGBD images) and inverse problems. In some examples, inputs provided to systems and methods described herein may be distance measurements, including an output of a light detection and ranging (LiDAR) system or other distance measuring system. The distance measurement may be transformed using transformation systems and methods described herein, and an evaluated function may output a depth of field, such as a fused depth of field. The depth of field may be over a scene, and may be provided as input, for example to one or more autonomous driving systems. In this manner, one or more vehicles may be controlled using depth of field data calculated using methods and systems described herein based on input distance measurements from one or more measurement systems. The computational complexity may be reduced to O(N+M), where N may be a number of rays and M may be a number of parameters.

With implementation of the technique, acceleration of rendering images in comparison with state-of-art has been achieved with reduced loss. The technique may be applied for various applications of computer vision and/or graphics, e.g., self-driving cars, interior design, robotic vision, special effects, etc. While various advantages of example systems and methods have been described, it is to be understood that not all examples of the described technology may have all, or even any, of the described advantages.

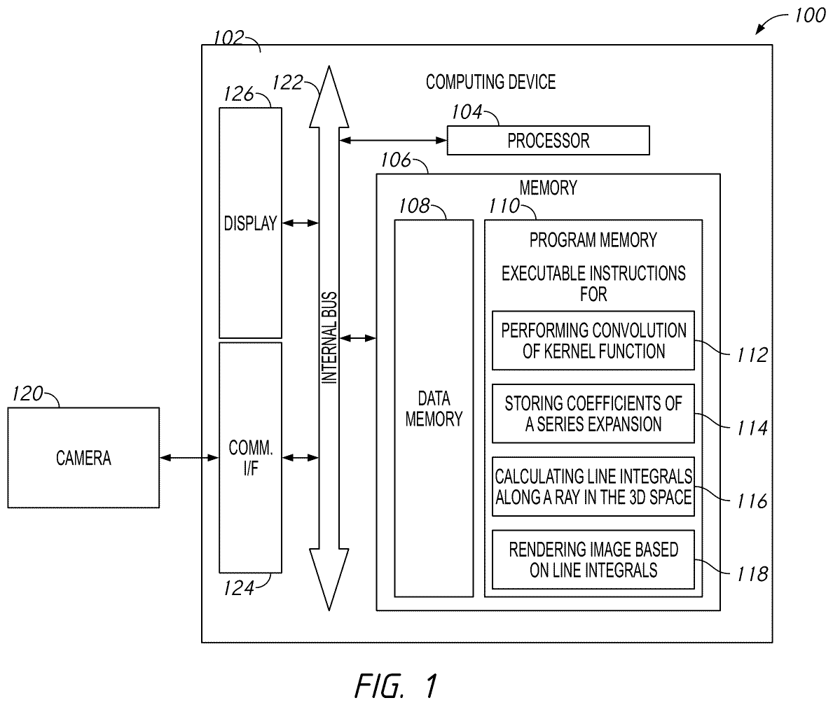

FIG. 1 is a schematic illustration of a system 100 in accordance with examples described herein. The system 100 includes a computing device 102 and a camera 120 coupled to the computing device 102. The computing device 102 includes components, such as a processor 104 and memory 106. The computing device 102 may also include a communication interface 124 and a display 126. The computing device 102 may further include an internal bus 122 that may provide communications between components included in the device 102, such as the processor 104, the memory 106, the communication interface 124, and the display 126. The memory 106 may include data memory 108 and program memory 110. The program memory 110 may be a non-transitory computer-readable medium storing computer-executable instructions, including instructions for performing convolution of kernel function 112, storing coefficients of a series expansion 114, calculating line integrals along a ray in the 3D space 116, and rendering image based on line integrals 118. The communication interface 124 may handle communications between the computing device 102 and external devices, including the camera 120.

The components of FIG. 1 are exemplary only. Additional, fewer, or different components may be used in other examples.

Examples of systems described herein may include a computing device, such as the computing device 102. A computing device, such as the computing device 102, may be implemented using a desktop or laptop computer, a smart device such as a smartphone or a wearable device, a workstation, or any computing device that may have computational functionality. The computing device 102 may be configured to be coupled to the camera 120.

Example of computing devices described herein may generally include one or more processors, such as the processor 104 of FIG. 1. Processors, such as the processor 104, may be implemented using one or more central processing units (CPUs), graphics processing units (GPUs), field programmable gate arrays (FPGAs), application specific integrated circuits (ASICs), controllers, microcontrollers, or other circuitry. Processors described herein may be used to implement software and/or firmware systems. For example, the processor 104 may be used to execute one or more executable instructions encoded on computer-readable media (e.g., memory). While a single processor 104 is shown in FIG. 1, it is to be understood that any number of processors may be used, and multiple processors may be in communication with each other to perform functions of a processor described herein. The processor 104 may be coupled to (e.g., in communication with), the memory 106, the communication interface 124, and/or one or more displays 126 of FIG. 1 via the internal bus 122.

Examples of computing devices described herein may include memory, such as the memory 106 of FIG. 1. Generally, any number or kind of memory may be used including read-only memory (ROM), random access memory (RAM), flash memory, one or more solid state drives, one or more hard disks, one or more SD cards, or other computer-readable media. The memory 106 may include the program memory 110 and the data memory 108. In some examples, the program memory 110 and the data memory 108 may be implemented as separate segments of the memory 106 as one or more integrated memory devices. In some examples, the program memory 110 and the data memory 108 may be implemented as separate memory devices of the same kind or different kinds. In some examples, any of the program memory 110 and/or the data memory 108 may be fixed in the computing device 102. In some examples, any of the program memory 110 and/or the data memory 108 may be attachable to and detachable from the computing device 102. The program memory 110 may be implemented as a non-transitory computer-readable medium storing computer-executable instructions, such as performing convolution of kernel function 112, storing coefficients of a series expansion 114, calculating line integrals along a ray in the 3D space 116, and rendering image based on line integrals 118.

The data memory 108 described herein may store data. In some examples, the data to be stored in the data memory 108 may include, for example, data for performing instructions encoded in the program memory 110, including data of one or more images, parameters to represent a kernel function at each of a plurality of source locations, weights for the plurality of source locations, coefficients of a series expansion for each voxel in a 3D space, line integrals along a ray in the 3D space, etc. In some examples, the data stored in the data memory 108 may include data to be exchanged with external devices. For example, the data to be exchanged may include image data received from the camera 120 and image data rendered to be provided to another external device. While a single memory 106 is shown in FIG. 1, it is to be understood that any number of memory devices may be used, and the executable instructions and/or data may be distributed across multiple memories accessible to the processor 104.

Example of computing devices described herein may include additional components. For example, the computing device 102 may include or be coupled to output devices. In some examples, the output devices may be one or more display(s), such as the display 126 of FIG. 1, and/or speakers. While FIG. 1 shows the display 126 integrated into the computing device 102, the display 126 or any output devices may be external devices coupled to the computing device 102. For example, the computing device 102 may include or be coupled to input devices. In some examples, the input device(s) may include keys, button, keyboards, mice, touchscreens, microphones, etc. The additional components in the computing device 102 may communicate with the processor 104 and/or the memory 106 of FIG. 1 via the internal bus 122. The computing device 102 may further include the communication interface 124 (e.g., cellular antenna, Wi-Fi, network interface, Bluetooth interface) of FIG. 1 that may communicate wirelessly or via wire(s) such as universal serial bus (USB) cables, ether cables, Hi-definition multimedia interface (HDMI) cables, or other standardized or proprietary cables. The additional components and/or the camera 120 coupled to the computing device 102 may communicate with the computing device 102 via the communication interface 124.

Examples of systems described herein may include a camera, such as the camera 120 described herein. In some examples, the camera 120 may be a depth camera, such as a pinhole camera. The camera 120 captures an image. The computing device 102 may collect, using the camera 120, a distance to at least one object, and normalize the distance to fit into a domain of expansion to be used. Thus, the processor 104 may extract a coherent 3D representation from images collected with the depth camera. Other camera devices may additionally or instead be used to implement the camera 120. The camera 120 may generally capture an image (e.g., obtain pixel data associated with an image).

The camera 120 may capture one or more images of an object. The one or more images may be transmitted to the computing device 102, and received by the communication interface 124 of the computing device 102 and stored in the data memory 108. The processor 104 of the computing device 102 may execute instructions for performing convolution of kernel function 112 located at each of a plurality of source locations of the object and weighted by input weights.

In some examples, the kernel function may be Gaussian kernel function. In order to perform series expansion based on FC2T2, the kernel function, a number of levels that controls the grid granularity, and an order of the expansion may be used as inputs. Based on the inputs, the processor 104 may obtain the kernel function that provides an expansion given source locations and weights and an array (e.g., accessor object) that allows to query function values and partial derivatives. In some examples, the kernel function values and partial derivatives are approximated by a polynomial fit. In some examples, the array may be a five dimensional (5D) numpy array with shape (B;C;N;N;N). The last three dimensions N in the array may denote spatial dimensions and are handled differently while the batch and channel dimensions behave exactly like those of a numpy array. In contrast to a numpy array, for the spatial dimensions, the array allows for querying data at continuous locations while using an input for every dimension. The spatial dimensions may accept any combination of a float scalar, a 1D float vector, or a slice. In some examples, query data may be provided in a volume. When querying data in a volume, a meshgrid of individual inputs to the spatial dimension may be formed. The processor 104 may execute instructions for storing coefficients of a series expansion 114 to cause the data memory 108 to store, as a result of the convolution, for each voxel in a 3D space, coefficients of a series expansion.

The processor 104 may execute instructions for calculating line integrals along a ray in the 3D space 116 to calculate line integrals along a ray in the 3D space using the coefficients of the series expansion in voxels along at least a portion of the ray. In some examples, the processor 104 may find a root along the ray intersecting the voxels, and convert 3D Taylor expansions represented by the voxels into univariate polynomials. In some examples, the processor 104 may provide a surface gradient that is a scalar-multiple of a surface normal at each root, where the roots may define a surface of the object. The processor 104 may further execute instructions for rendering an image based on line integrals 118 to render the image based, at least in part, on the line integrals.

The technology of the system 100 may provide various image processing applications in 3D space. In some examples, using color images of an object, for example, RGB images, and optionally viewpoints of the images, a rendering of the object from new viewpoints may be obtained. In some examples, using a 3D model of a face and text, an animation of the 3D model with its narration may be obtained with an aid of generative artificial intelligence (AI) technology.

It should be understood that this and other arrangements and elements (e.g., machines, interfaces, function, orders, and groupings of functions, etc.) can be used in addition to or instead of those shown, and some elements may be omitted altogether. Various functions described herein as being performed by one or more components may be carried out by firmware, hardware, and/or software.

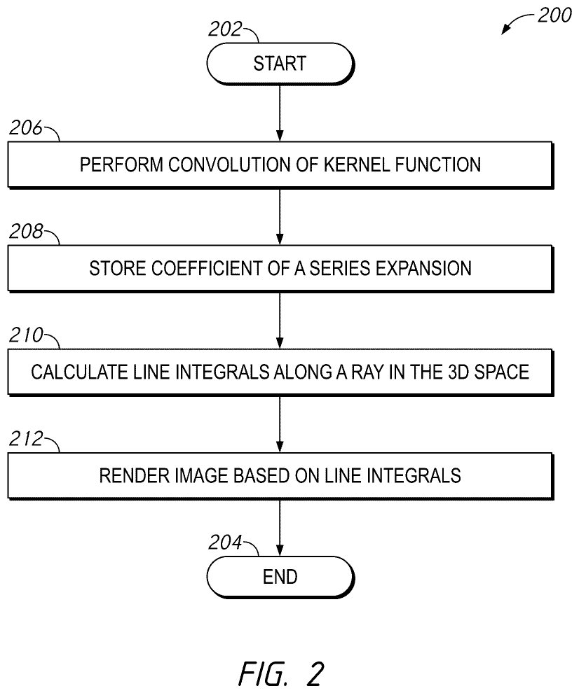

FIG. 2 is a schematic illustration of a flowchart 200 of a method with examples described herein. Example operations of the method are described to support the functionality, and relevant design decisions are described herein. In the example operations, a procedure of rendering an image is described. In some examples, the method may be operated by the system 100; however, any system with the same or different configuration may perform the method in an analogous fashion.

The flowchart 200 includes blocks 206-212. The actions shown in flowchart 200 of FIG. 2 may be taken by the system 100 of FIG. 1 in some examples. For example, the executable instructions shown and described in FIG. 1 may include instructions for performing the operations shown and described in the flowchart 200. The flowchart 200 is exemplary only. Additional, fewer, and/or different operations may be included in other examples.

Example operations of the system 100 for rendering an image are described to support the functionality, and relevant design decisions are described herein. Example operations of rendering an image may be a procedure that leverages series expansions based on convolutions to perform approximation to reduce computational complexity and time. During the procedure, a convolution of a kernel function located at each of a plurality of source locations and weighted by input weights may be performed. As a result of the convolution, coefficients of a series expansion may be stored for each voxel in a 3D space. Using the coefficients of the series expansion in voxels along at least a portion of the ray, line integrals along a ray in the 3D space may be calculated. Based, at least in part, on the line integrals, the image may be rendered.

In some examples, in start operation 202 of the technique, one or more images may be captured by the camera 120. The one or more images may be transmitted to the computing device 102, and received by the communication interface 124 of the computing device 102 and stored in the data memory 108. The computing device 102 may collect, using the camera 120, a distance to at least one object, and normalize the distance to fit into a domain of expansion to be used. Thus, the processor 104 may extract a coherent 3D representation from the one or more images collected with the camera 120.

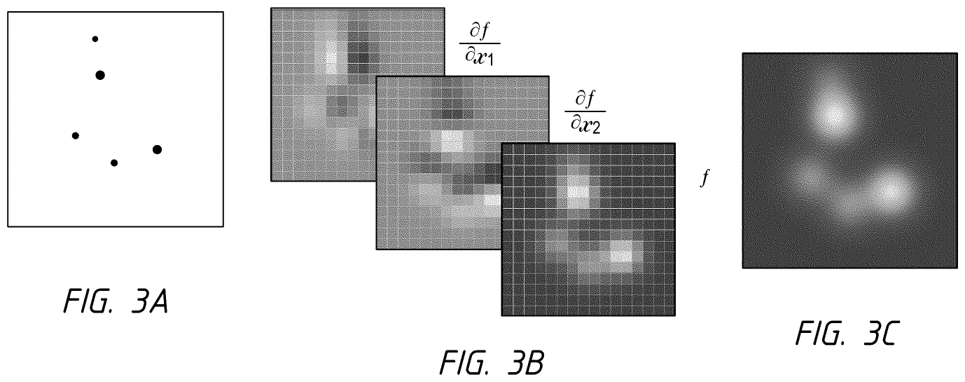

In operation 206, the processor 104 of the computing device 102 may perform convolution of kernel function located at each of a plurality of source locations of the object and weighted by input weights. In some examples, the inputs are continuous spatial locations and weights as shown in FIG. 3A. Weights are represented by dot size in the graphic. In some examples, the kernel function may be a Gaussian kernel function. In order to perform series expansion based on FC2T2, the kernel function, a number of levels that controls the grid granularity, and an order of the expansion may be used as inputs. In some examples, the processor 104 may cause the computing device 102 to control an order of the series expansion based on computer resource usage of the computing device 102.

Based on the inputs, the processor 104 may cause the computing device 102 to obtain the kernel function that provides an expansion given source locations and weights and an array (e.g., accessor object) that allows to query function values and partial derivatives. The FC2T2 may discretize space and compute a series expansion for every cell within the grid. Given N input locations, this step is in O(N). FIG. 3B illustrates a series expansion in accordance with examples described herein. The graphic illustrates a first order two dimensional (2D) expansion.

In some examples, the processor 104 may cause the computing device 102 to generate a local representation based on series expansion for each voxel and compute values of the function. In some examples, the processor 104 may cause the computing device 102 to control a size of each voxel. In some examples, the processor 104 may cause the computing device 102 to find model parameters of a neural network based on each of each of the plurality of source locations, the kernel function thereof, and the weight thereof, and provide the model parameters as feedback inputs. In some examples, the kernel function may be generated by machine learning. In some examples, the kernel function values and partial derivatives are approximated by a polynomial fit. In some examples, the array may be a 5D numpy array with shape (B;C;N;N;N). The last three dimensions N in the array may denote spatial dimensions and are handled differently while the batch and channel dimensions behave exactly like those of a numpy array. In contrast to a numpy array, for the spatial dimensions, the array allows for querying data at continuous locations while using an input for every dimension. The spatial dimensions may accept any combination of a float scalar, a 1D float vector, or a slice. In some examples, query data may be provided in a volume. When querying data in a volume, a meshgrid of individual inputs to the spatial dimension may be formed. In some examples, the processor 104 may cause the computing device 102 to extract gradients and partial derivatives of order 2. The gradients and partial derivatives may be extracted in a volume. In operation 208, the computing device 102 may store, in the data memory 108, coefficients of a series expansion as a result of the convolution, for each voxel in a 3D space.

In operation 210, the processor 104 may cause the computing device 102 to calculate line integrals using the coefficients of the series expansion in voxels along at least a portion of the ray. In some examples, the processor 104 may cause the computing device 102 to approximate JVP using a FC2T2 expansion, and provide the JVP for backpropagation in the neural network. In some examples, the processor 104 may cause the computing device 102 to find a root along the ray intersecting the voxels, and convert 3D Taylor expansions represented by the voxels into univariate polynomials. In some examples, the processor 104 may cause the computing device 102 to further compute integrals by splitting the integrals at intersections of the ray and voxels. In some examples, the processor 104 may cause the computing device 102 to provide a surface gradient that is a scalar-multiple of a surface normal at each root, where the roots may define a surface of the object. In some examples, the processor 104 may cause the computing device 102 to train a neural network by computing the integrals numerically to provide many neural network evaluations per ray. The processor 104 may further cause the computing device 102 to render an image based on line integrals 212 to render the image based, at least in part, on the line integrals. FIG. 3C illustrates outputs in accordance with examples described herein. Given the expansion, computing the output at M target locations is independent of N, for example, in O(M), resulting in O(N+M) for the entire procedure.

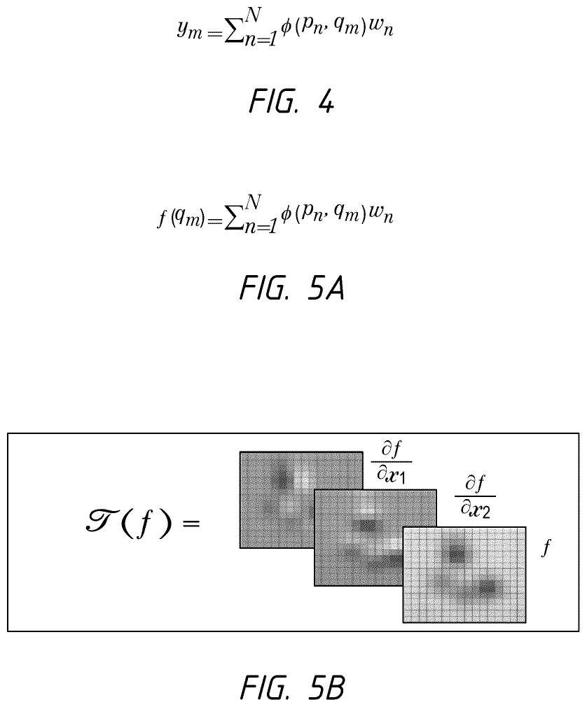

FIG. 4 shows an equation representing an approximation using the FMM. The FMM allows for an approximation represented in the equation of FIG. 4 with 1≤m≤M where M and N are sizes of input data sets. The FMM is an approximate technique to evaluate p and q in the equation of FIG. 4, oftentimes referred to as source and target locations respectively. While a naive approach to evaluating the equation of FIG. 4 at M target locations has the cost of computational complexity of O(NM), the FMM reduces this cost to O(N+M) at the expense of accuracy, i.e., by being approximate in nature. This technique may have the worst efficiency O(M+N) instead of O(MN) for some kernel functions ϕ under the assumption that pₙ and qₘ are low dimensional. The FMM allows for the efficient approximation of low-dimensional convolutional operators in continuous space. In the context of machine learning, N and M can be understood as numbers of model parameters and model evaluations respectively which entails that, for applications that use repeated function evaluations which are prevalent in computer vision and graphics, unlike regular neural networks, the techniques disclosed scale gracefully with parameters. For some applications, this results in a 200× reduction in floating point operations per second (FLOPS) compared to state-of-the-art approaches at a reasonable or non-existent loss in accuracy.

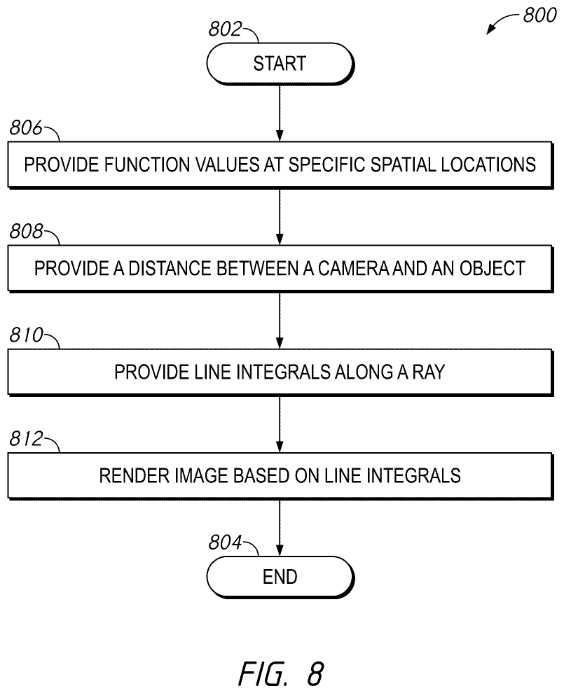

FIG. 5A shows an equation locally representing an approximation using the FMM in accordance with examples described herein. A base model of the method is a spatially continuous convolutional operator as shown in FIG. 5A. FIG. 5B illustrates a Taylor series expansion corresponding to the equation of FIG. 5A. The FMM technique is a two-step process. In the first step, p and w are expanded into a local expression by a series expansion represented by an equation in FIG. 5A. In some examples, the operations 806-810 in FIG. 8 may be performed in an iterative process of a backpropagation technique. For example, in a forward pass, in every iteration of the back propagation, operation as shown in FIG. 5A may be expanded into a voxel grid, that contains the 3D Taylor series expansions at voxel centers, as shown in FIG. 5B. Because of being expressed locally (e.g., on or proximate to a grid), p and q may be configured to be low dimensional. This first step has a computational cost of O(C_{expand}N) where C_{expand} is a controllable constant coefficient that increases with the accuracy. Traditionally, the FMM is employed in high-precision particle simulations in which only far-field interactions are approximated based on a series expansion, where interactions for which d(pₙ; qₘ)>ε hold for some metric d. Near-field interactions are typically resolved exactly. During a backward pass, a second expansion may be computed in order to compute JVPs. This operation may entail inserting quantities related to a tangent vector into the expansion.

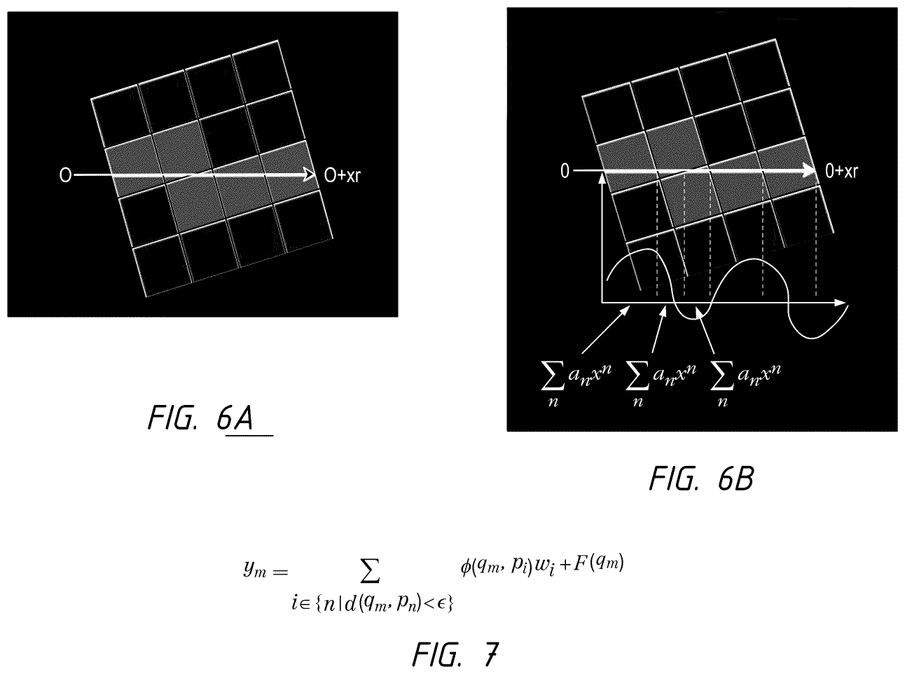

Since operations of implicit layers may provide quantities along a ray during the forward pass, the voxels that intersect the ray are enumerated, as shown in FIG. 6A. Because Taylor series expansions represent a local polynomial approximation, any line through a voxel can be converted into a univariate polynomial. Similarly to a Fourier space in which certain operations, such as convolutions, may be computed efficiently, other operations can be efficiently performed in Taylor space.

For example, a root-implicit layer, such as an operation 808 in FIG. 8, can be a fast solution for root finding of polynomials of order 4 or less that exist, as shown in FIG. 6B. For example, an integral-implicit layer, such as an operation 810 in FIG. 8, may be a solution for polynomial closure, where polynomials can be multiplied, composed, and integrated easily.

FIG. 7 shows an equation representing an approximation of near-field and far-filed interactions at spatial location qₘ using the FMM. The equation in FIG. 7 represents/as the expansion of far-field interactions evaluated at spatial location qₘ. In the traditional formulation of the FMM, after the price for expanding the far-field interactions has been paid, evaluating qₘ has a computational complexity of O((Cₑᵥₐₗ+Cₙₑₐᵣ)M) where Cₑᵥₐₗ denotes the controllable cost of evaluating the series expansion representing far-field interactions and Cₙₑₐᵣ denotes the cost of exactly resolving near-field interactions. The FMM algorithm reduces complexity of matrix-vector multiplication involving some dense matrix which may arise out of many physical systems.

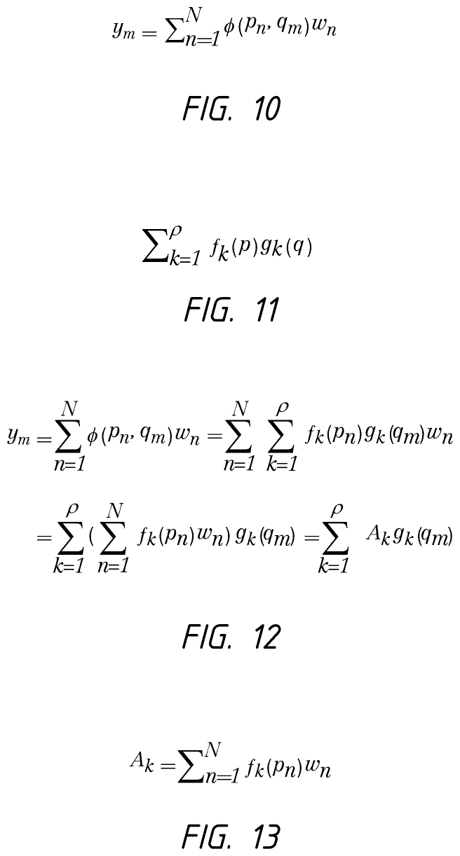

Detailed explanation of the operations described with regard to FIGS. 4-7 may be further provided referring to FIGS. 10-32.

Approximations using series expansions on a fixed grid of a continuous convolutional operator have been described through FIGS. 1-6. FIG. 8 provides operations that may use the series expansions in the context of gradient based learning.

FIG. 8 is a schematic illustration of a flowchart 800 of a method with examples described herein. Example operations of the method are described to support the functionality, and relevant design decisions are described herein. In the example operations, a procedure of rendering an image is described. In some examples, the method may be operated by the system 100; however, any system with the same or different configuration may perform the method in an analogous fashion.

The flowchart 800 includes blocks 806-810. The actions shown in flowchart 800 of FIG. 8 may be taken by the system 100 of FIG. 1 in some examples. For example, the executable instructions shown and described in FIG. 1 may include instructions for performing the operations shown and described in the flowchart 800. The flowchart 800 is exemplary only. Additional, fewer, and/or different operations may be included in other examples. The order of the operations may not be limited to the flowchart 800 including blocks 806-810. Some of the operations may be omitted, or some other operations may be added, or the operations may be performed in a different order.

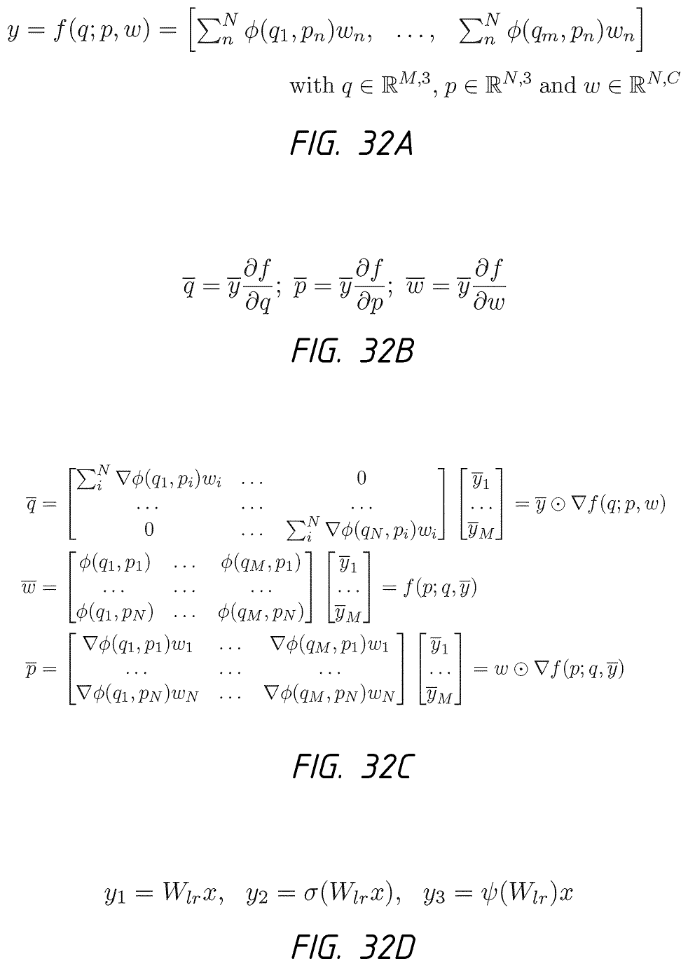

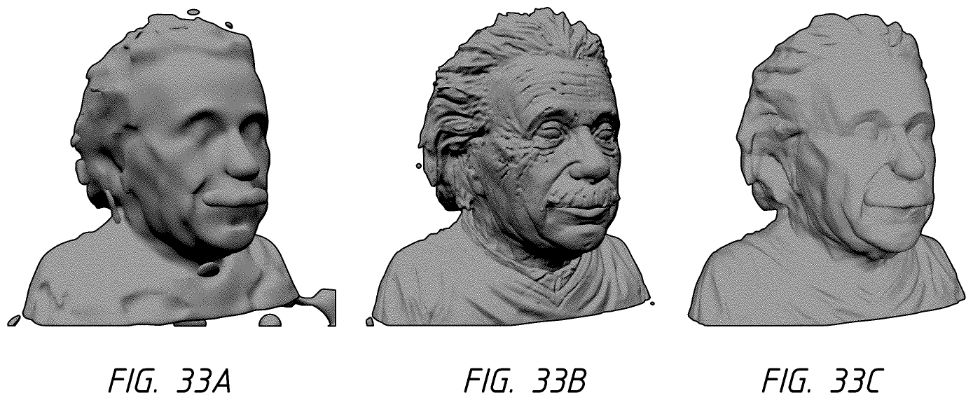

In some examples, function values at specific spatial locations may be provided (e.g., an explicit layer) in an operation 806. For example, operations, such as the operation 806, may be used to model sign distance functions (SDFs). Training the explicit layer with a considerable number of samples may reduce a number of FLOPS compared to the deep SDF architecture. A detailed explanation of the operation 806 may be provided referring to FIGS. 32A-33C.

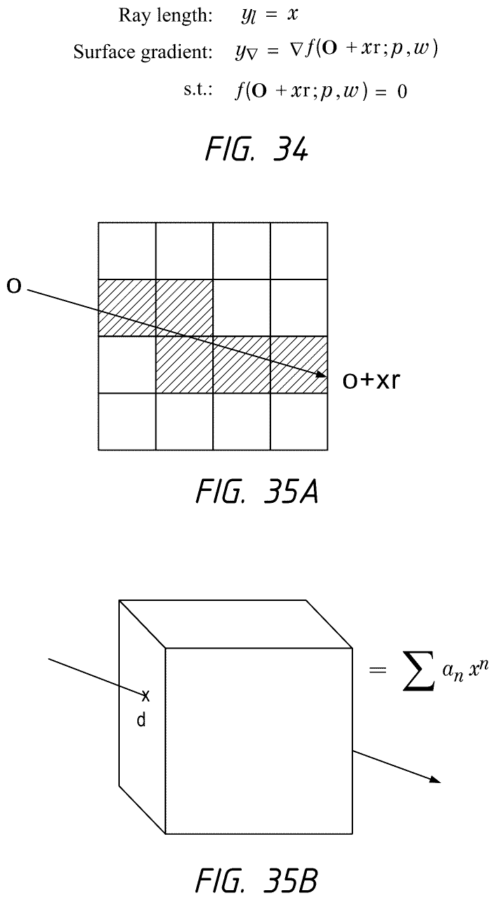

In some examples, a distance between a camera and an object may be provided (e.g., a root-implicit layer) in an operation 808. For example, the operation 808 may provide surface normals and object distances. Operations combining the operation 808 of explicit layer and the operation 808 of root-implicit layer may represent RGBD images, where the operation 808 may perform modeling a depth and the operation 806 may perform modeling colors (RGB). From a single RGBD image, images from unseen viewpoints may be rendered. A detailed explanation of the operation 808 may be provided referring to FIGS. 34-42.

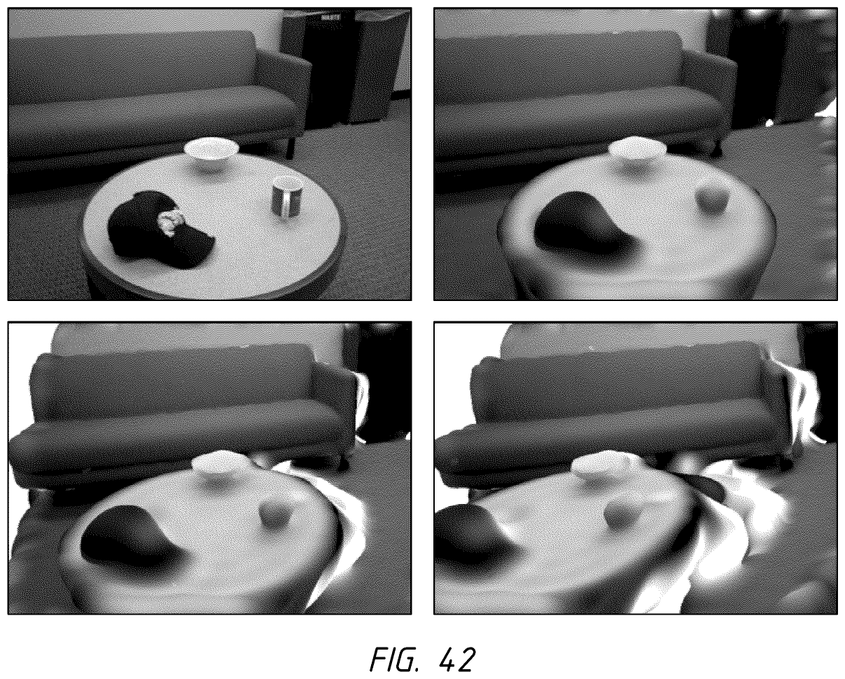

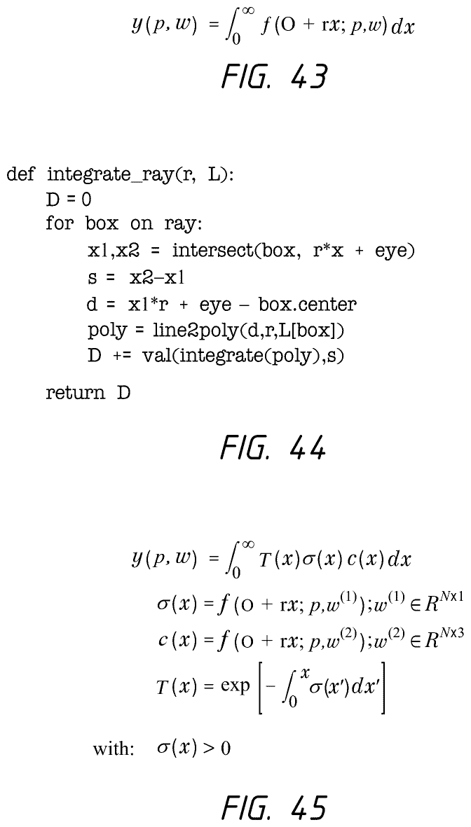

In some examples, line integrals along a ray may be provided (e.g., an integral-implicit layer) through an operation 810. The operation 810 may provide rendering of a radiance field given a 3D pose. The operation 810, such as a single integral-implicit layer, may be used to train radiance fields. For example, the single integral-implicit layer may be trained based on 2D images annotated with viewpoints. By training the integral-implicit layer, FLOPS may be further reduced compared to the neural network-based techniques. A detailed explanation of the operation 810 may be provided referring to FIGS. 43-52D.

Based on the line integrals, in operation 812 an image from a specific viewpoint selected may be obtained and ends the procedure at block 804.

The operations described in FIG. 8 may be used for different applications. For example, a system 900 may provide a model describing positional relationships about physical properties to compute certain physical property at a specific location. Any physical property that may vary over positions may be described. The physical property may be, for example, light intensity. In other examples, the physical property may be air/molecular movements. For example, fog, smoke or steam, sound, etc., that are continuous across positions, may be simulated. Furthermore, rendering solid objects may be possible. For example, a pressure field around an automobile or other vehicle may be simulated using the model.

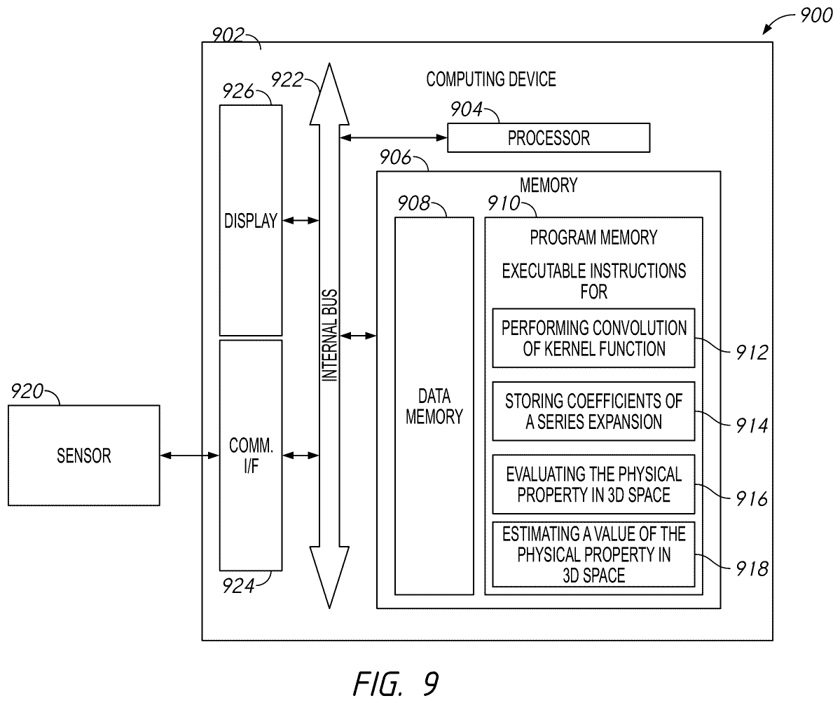

FIG. 9 is a schematic illustration of the system 900 in accordance with examples described herein. The system 900 includes a computing device 902 and a sensor 920 coupled to the computing device 902. The computing device 902 includes components, such as a processor 904 and memory 906. The computing device 902 may also include a communication interface 924 and a display 926. The computing device 902 may further include an internal bus 922 that may provide communications between components included in the device 902, such as the processor 904, the memory 906, the communication interface 924, and the display 926. The memory 906 may include data memory 908 and program memory 910. The program memory 910 may be a non-transitory computer-readable medium storing computer-executable instructions, including performing convolution of kernel function 912, storing coefficients of a series expansion 914, evaluating the physical property in 3D space 916, and estimating a value of the physical property in 3D space 918. The communication interface 924 may handle communications between the computing device 902 and external devices, including the sensor 920.

Examples of systems described herein may include a computing device, such as the computing device 902. A computing device, such as the computing device 902, may be implemented using a desktop or laptop computer, a smart device such as a smartphone or a wearable device, a workstation, or any computing device that may have computational functionality. The computing device 902 may be configured to be coupled to the sensor 920.

Example of computing devices described herein may generally include one or more processors, such as the processor 904 of FIG. 9. Processors, such as processor 904, may be implemented using one or more CPUs, GPUs, FPGAs, ASICs, controllers, microcontrollers, or other circuitry. Processors described herein may be used to implement software and/or firmware systems. For example, the processor 904 may be used to execute one or more executable instructions encoded on computer-readable media (e.g., memory). While a single processor 904 is shown in FIG. 9, it is to be understood that any number of processors may be used, and multiple processors may be in communication with each other to perform functions of a processor described herein. The processor 904 may be coupled to (e.g., in communication with), the memory 906, the communication interface 924, and/or one or more displays 926 of FIG. 9 via the internal bus 922.

Examples of computing devices described herein may include memory, such as the memory 906 of FIG. 9. Generally, any number or kind of memory may be used including ROM, RAM, flash memory, one or more solid state drives, one or more hard disks, one or more SD cards, or other computer-readable media. The memory 906 may include program memory 910 and data memory 908. In some examples, the program memory 910 and the data memory 908 may be implemented as separate segments of the memory 906 as one or more integrated memory devices. In some examples, the program memory 910 and the data memory 908 may be implemented as separate memory devices of the same kind or different kinds. In some examples, any of the program memory 910 and/or the data memory 908 may be fixed in the computing device 902. In some examples, any of the program memory 910 and/or the data memory 908 may be attachable to and detachable from the computing device 902. The program memory 910 may be implemented as a non-transitory computer-readable medium storing computer-executable instructions, such as performing convolution of kernel function 912, storing coefficients of a series expansion 914, evaluating the physical property in 3D space 916, and estimating a value of the physical property in 3D space 918.

The data memory 908 described herein may store data. In some examples, the data to be stored in the data memory 908 may include, for example, data for performing instructions encoded in the program memory 910, including data of one or more images, parameters to represent a kernel function at each of a plurality of source locations, weights for the plurality of source locations, coefficients of a series expansion for each voxel in a 3D space, line integrals along a ray in the 3D space, etc. In some examples, the data stored in the data memory 908 may include data to be exchanged with external devices. For example, the data to be exchanged may include physical data related to positions received from the sensor 920 and physical property data to be provided to another external device. While a single memory 906 is shown in FIG. 9, it is to be understood that any number of memory devices may be used, and the executable instructions and/or data may be distributed across multiple memories accessible to the processor 904.

Example of computing devices described herein may include additional components. For example, the computing device 902 may include or be coupled to output devices. In some examples, the output devices may be one or more display(s), such as the display 926 of FIG. 9, and/or speakers. While FIG. 9 shows the display 926 integrated into the computing device 902, the display 926 or any output devices may be external devices coupled to the computing device 902. For example, the computing device 902 may include or be coupled to input devices. In some examples, the input device(s) may include keys, button, keyboards, mice, touchscreens, microphones, etc. The additional components in the computing device 902 may communicate with the processor 904 and/or the memory 906 of FIG. 9 via the internal bus 922. The computing device 902 may further include the communication interface 924 (e.g., cellular antenna, Wi-Fi, network interface, Bluetooth interface) of FIG. 9 that may communicate wirelessly or via wire(s) such as USB cables, ether cables, HDMI cables, or other standardized or proprietary cables. The additional components and/or the sensor 920 coupled to the computing device 902 may communicate with the computing device 902 via the communication interface 924.

Examples of systems described herein may include image sensors, biomechanical sensors, or monitoring sensors, such as the sensor 920 described herein. In some examples, the sensor 920 may detect physical properties of an object associated with a distance and a direction. The computing device 902 may collect, using the sensor 920, a distance to at least one object, and normalize the distance to fit into a domain of expansion to be used. Thus, the processor 904 may extract a coherent 3D representation from the physical properties collected with the sensor 920.

The sensor 920 may detect one or more physical properties of an object. The one or more physical properties may be transmitted to the computing device 902, and received by the communication interface 924 of the computing device 902 and stored in the data memory 908. The processor 904 of the computing device 902 may execute instructions for performing convolution of kernel function 912 located at each of a plurality of source locations of the object and weighted by input weights.

In some examples, the kernel function may be a Gaussian kernel function. In order to perform series expansion based on FC2T2, the kernel function, a number of levels that controls the grid granularity, and an order of the expansion may be used as inputs. In some examples, the processor 904 may control an order of the series expansion based on computer resource usage of the computing device 902. Based on the inputs, the processor 904 may obtain the kernel function that provides an expansion given source locations and weights and an array (e.g., accessor object) that allows to query function values and partial derivatives. In some examples, the processor 904 may generate a local representation based on series expansion for each voxel, and compute values of the function. In some examples, the processor 904 may control a size of each voxel. In some examples, the processor 904 may find model parameters of a neural network based on each of each of the plurality of source locations, the kernel function thereof, and the weight thereof, and provide the model parameters as feedback inputs. In some examples, the kernel function may be generated by machine learning. In some examples, the kernel function values and partial derivatives are approximated by a polynomial fit. In some examples, the array may be a 5D numpy array with shape (B;C;N;N;N). The last three dimensions N in the array may denote spatial dimensions and are handled differently while the batch and channel dimensions behave exactly like those of a numpy array. In contrast to a numpy array, for the spatial dimensions, the array allows for querying data at continuous locations while using an input for every dimension. The spatial dimensions may accept any combination of a float scalar, a 1D float vector, or a slice. In some examples, query data may be provided in a volume. When querying data in a volume, a meshgrid of individual inputs to the spatial dimension may be formed. In some examples, the processor 904 may extract gradients and partial derivatives of order 2. The gradients and partial derivatives may be extracted in a volume. The processor 904 may execute instructions for storing coefficients of a series expansion 914 to cause the data memory 908 to store, as a result of the convolution, for each voxel in a 3D space, coefficients of a series expansion.

The processor 904 may execute instructions for evaluating the physical property in 3D space 916. In some examples, the processor 904 may approximate JVP using a FC2T2 expansion, and provide the JVP for backpropagation in the neural network. In some examples, the processor 904 may find a root along the ray intersecting the voxels, and convert 3D Taylor expansions represented by the voxels into univariate polynomials. In some examples, the processor 904 may further compute integrals by splitting the integrals at intersections of the ray and voxels. In some examples, the processor 904 may provide a surface gradient that is a scalar-multiple of a surface normal at each root, where the roots may define a surface of the object. The processor 904 may further execute instructions for estimating a value of the physical property in 3D space 918 to provide the physical properties based, at least in part, on the line integrals. In some examples, the processor 904 may train a neural network by computing the integrals numerically to provide many neural network evaluations per ray.

The technology of the system 900 may provide various applications regarding physical property in 3D space. In some examples, using one or more measurements of LiDAR technique or any other distance meter as input, a (fused) depth field may be obtained. This technique may be applied for vehicle autonomous driving technologies. In some examples, using a sequence of measurements by the LiDAR technique, a fused 3D model of an environment may be obtained. For example, 3D information of a house may be imported into simulation systems and displayed to users. In some examples, a class of objects (e.g. airplanes) may be provided as input to the system 900, and novel instances of the objects may be obtained using the generative AI technologies. In some examples, physical measurements of a phenomenon in a 3D space at multiple time points may be provided as input, and the system 900 may provide prediction of the phenomenon into the future (e.g. climate measurements). In some examples, molecular composition of a material may be provided as input to the system 900 and refraction of that material may be computed as an output.

It should be understood that this and other arrangements and elements (e.g., machines, interfaces, function, orders, and groupings of functions, etc.) can be used in addition to or instead of those shown, and some elements may be omitted altogether. Various functions described herein as being performed by one or more components may be carried out by firmware, hardware, and/or software.

Examples of FC2T2 operations are described herein.

The general idea of the FMM following the structure considering the Taylor series as the underlying expansion will be explained with regard to FIGS. 10-32. FIGS. 10-20 show mathematical equations and/or approximations representing a process of obtaining FC2T2 in accordance with examples described herein. The equations of FIGS. 10-20 to perform FC2T2 may be evaluated in accordance with the executable instructions for performing convolution of kernel functions 112 and 912 of FIGS. 1 and 9. As described earlier, the FMM is an approximate technique to evaluate yₘ as shown in the equation of FIG. 10. In the context of the FMM, p and q are oftentimes referred to as source and target locations respectively and a naive approach to evaluating the equation of FIG. 10 at M target locations has the cost of computational complexity of O(NM); the FMM reduces this cost to O(N+M) at the expense of accuracy, for example, by being approximate in nature.

When assuming ϕ as a degenerate kernel that can be decomposed into functions of p and 1, as shown in the equation of FIG. 11. For such a kernel, computational complexity of evaluating yₘ can be approximated into O(ρN+ρM) in a trivial way by simple arithmetic as shown in equations of FIG. 12. Because Aₖ is independent of any information of the target locations q as shown in an equation FIG. 13, it can be computed once in O(ρN). After computing and storing Aₖ, evaluating yₘ is in O(ρM), thus rendering the entire strategy to be in O(ρN+ρM). However, choosing ϕ to be degenerate may significantly limit the expressiveness of y and thus the type of functions that could potentially be approximated by y.

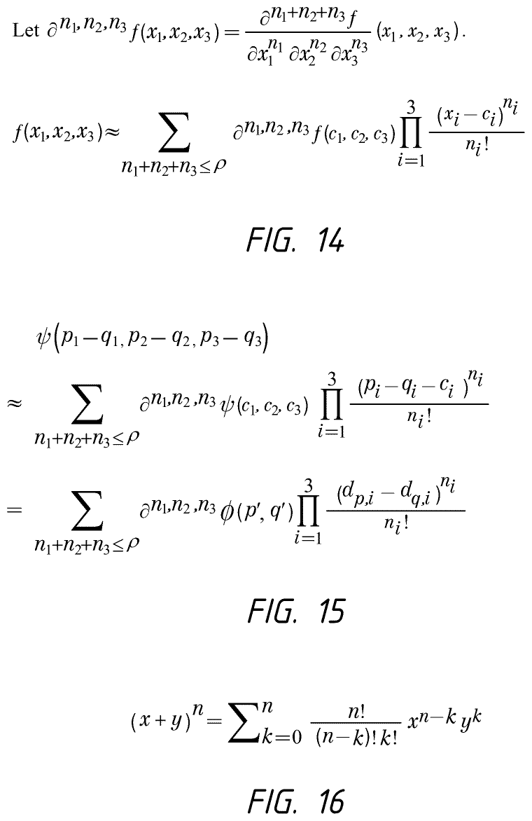

The FMM technique may have a similar concept as the degenerate kernel example above. Approximating the kernel ϕ by a truncated series expansion allows for separation of effects of target and source locations which ultimately will allow the collection of terms in the same manner as the degenerate kernel example above. The order of the series expansion then controls or trades among computation, memory, and accuracy. Assume an approximation of the kernel ϕ by a 3D Taylor series expansion, such as p∈ [symbol] ³. Furthermore, when a kernel for which the following holds: ϕ(p, q)=ψ(p₁−q₁, p₂−q₂, p₃−q₃), for the 3D Taylor series expansion centered at c=[c₁; c₂; c₃] truncated to order ρ, an approximation may be represented as a formula of FIG. 14.

Assume that pᵢ−p′ᵢ and qᵢ−q′ᵢ may be sufficiently small such that the Taylor expansion centered at c converges. Furthermore, let cᵢ=p′ᵢ−q′ᵢ, d_{p,i}=pᵢ−p′ᵢ and d_{q,i} analogously. Applying the 3D Taylor series expansion to ϕ then yields an approximation and equation shown in FIG. 15.

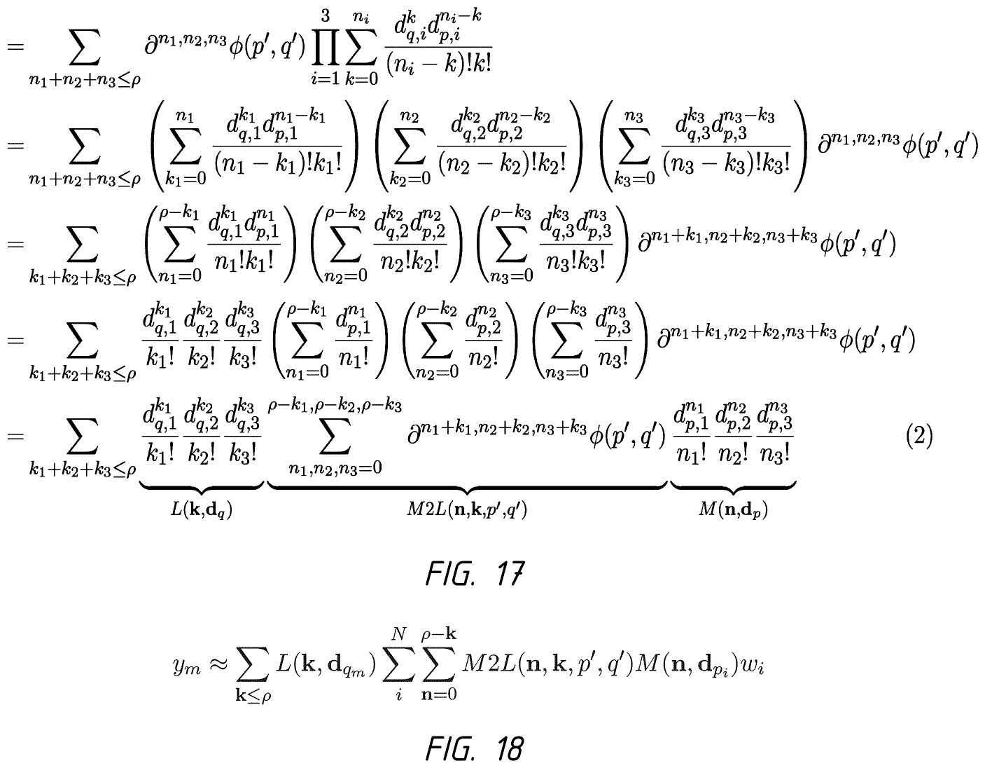

Using a binomial theorem of FIG. 16 and some computation, equations may be developed as shown in FIG. 17. Thus, yₘ may be approximated as shown in FIG. 18.

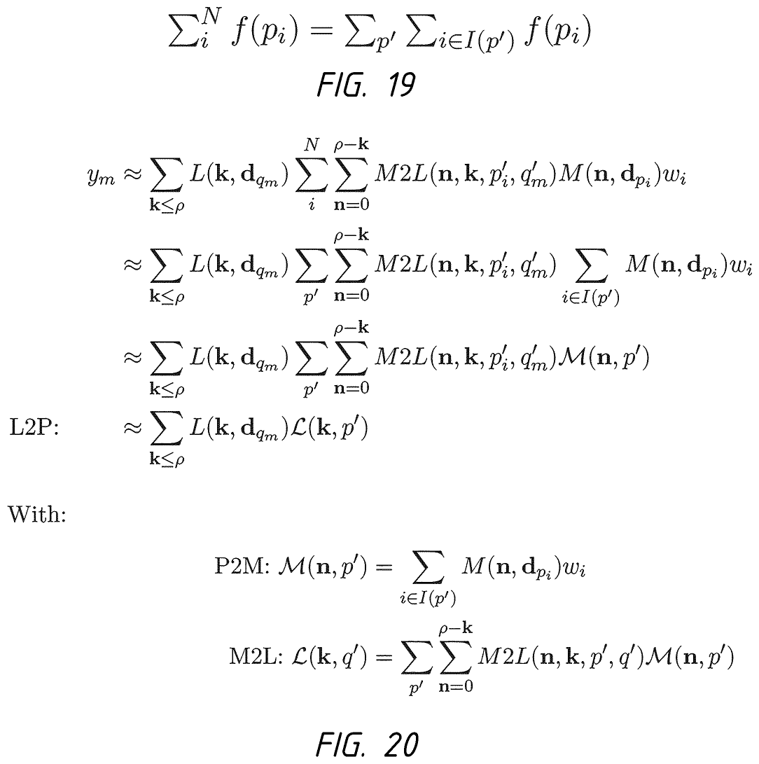

Note that all terms in M and L are independent of target and source locations respectively. Thus a separation is achieved similar to the example of the degenerate kernel by approximating the kernel ϕ with a truncated series expansion. The derivations above could already be turned into an approximation technique that resolves yₘ. Considering a discretization of the domain into non-overlapping boxes, the centers may be denoted as p′ and q′ if p′ᵢ is the box that contains particle pᵢ and q′ᵢ analogously. Furthermore, if I(p′) is the set of all indices of particles contained in box p′, because the boxes are non-overlapping, a relationship may be represented in the equation in FIG. 19.

Thus, yₘ may be further computed to obtain the approximation of L2P with equations of P2M and M2L in FIG. 20.

The technique above may collect the effects of all source points into their respective boxes p′. In some examples, this step is called P2M. Then, in order to obtain a Taylor expansion at location q′, all cells p′ are convolved with the M2L kernel.

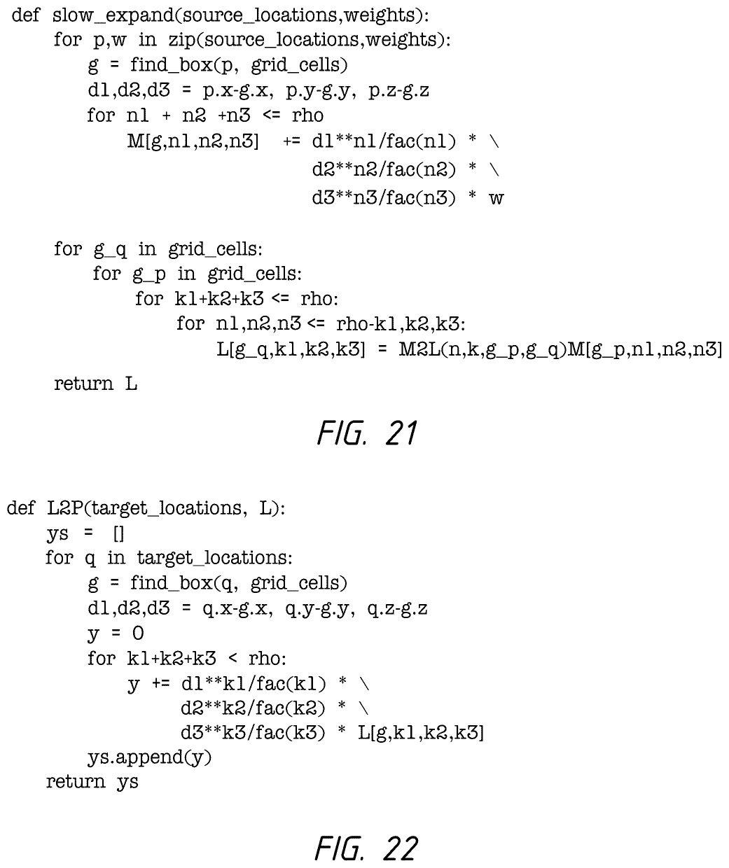

FIGS. 21 and 22 are pseudo code illustrating an example of FC2T2 in accordance with examples described herein. The pseudo code of FIG. 21 illustrates a series expansion function based source locations and weights as inputs.

The pseudo code of FIG. 22 illustrates an L2P function that allows to query data from the expansion. The technique described above may separate a number of source and target locations in terms of computational complexity.

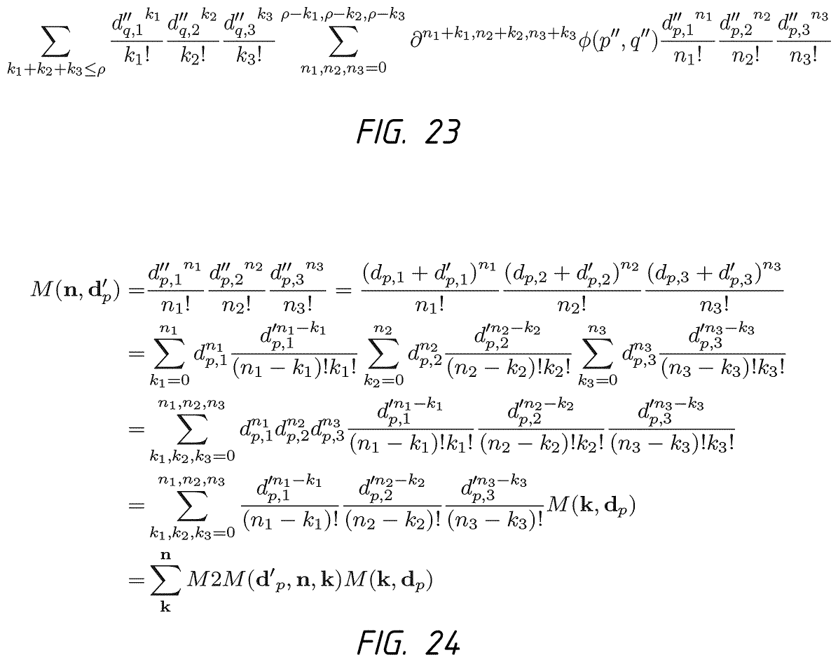

When G is a number of grid cells, the computational complexity is O(G²+N+M). To be in a practical computational speed, computational complexity may further be reduced. In some examples, a radius of convergence of ϕ may be assumed to increase exponentially with a distance from a center of the kernel that may resolve the M2L procedure for boxes that are further apart from each other at a lower spatial resolution. By this assumption, an expansion may be significantly faster by resolving longer range interactions between boxes at a lower spatial resolution. For example, the M-expansion of adjacent boxes may be collected into a single larger box when p″ and q″ denote the centers of the larger boxes. The maximum size of the larger boxes depends on the radius of convergence of ¢ at the desired distance. Thus, a Taylor expansion at p′−q′ may not be performed. Instead, a Taylor expansion at a distance of p″−q″ with p″=p′+d′ₚ and q″ analogously may be performed. This entails that d_{p,i}+d′ₚ=pᵢ−p″ᵢ=: d″_{p,i} and d_{q,i}+d′_{q}=qᵢ−q″=: d″_{q,i}. Applying these into an equation (2) in FIG. 17 provides a computation represented in FIG. 23.

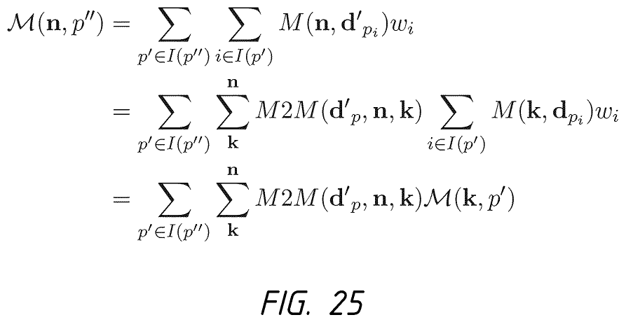

By computing M-terms independently and applying the binomial theorem of FIG. 16, the relationship of FIG. 24 may be obtained. When I(p″) is the set of all boxes p′ contained in the box p″, the relationship represented equations of FIG. 25 may be obtained.

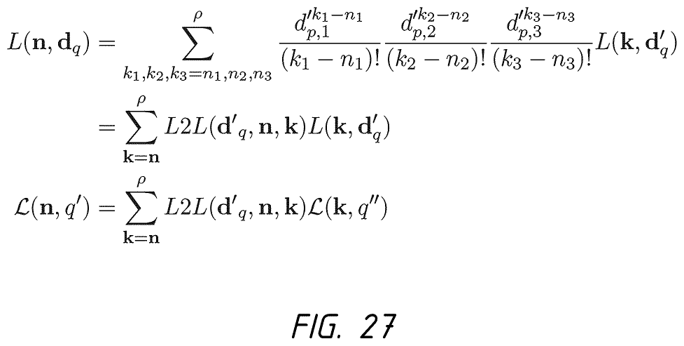

Once the M2M procedure has been applied, a lower resolution L-expansion can be obtained by applying the M2L procedure. This L-expansion may be valid if the distance between boxes supplied to the M2L kernel is large enough, for example, every spatial resolution is associated with a minimum distance at which interactions can be resolved. Although computationally inefficient, high spatial resolutions allow for resolving long range interactions; still, low spatial resolution expansions cannot accurately resolve short range interactions. In order to avoid having to loop over L-expansions at multiple spatial resolutions when performing L2P, the L-expansions for large boxes may be sorted into those of smaller boxes. Such sorting may be performed by an operation called L2L, analogous to M2M, as equations shown in FIG. 27.

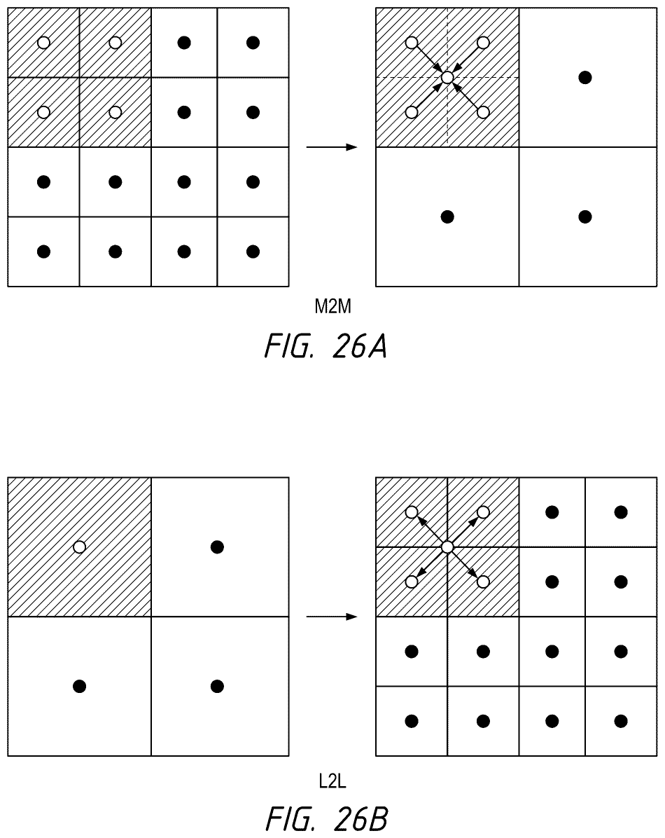

FIGS. 26A and 26B illustrate types of kernels in accordance with examples described herein. The M2M and L2L kernels allow for a multilevel variant that significantly speeds up the M2L procedure by resolving longer range interactions at lower spatial resolutions.

FIG. 26A illustrates an M2M kernel. By performing the M2M kernel, an M-expansion may be recursively obtained at a lower spatial resolution. Lower resolution M-expansions may be used to resolve longer range M2L interactions more efficiently because of including fewer boxes.

FIG. 26B illustrates an L2L kernel. The L2L kernel may be used to hierarchically sort L-expansions of a lower spatial resolution into a higher resolution L-expansion to ultimately obtain a single L-expansion that represents interactions of all ranges.

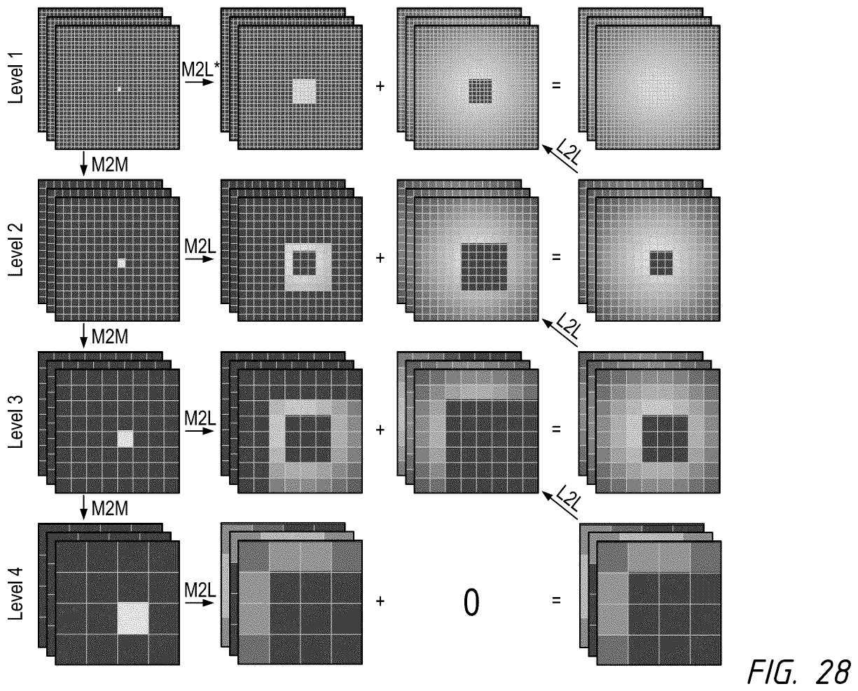

The process of sorting source points into the largest M-expansion is traditionally referred to as P2M whereas evaluating the function value at a specific location is called L2P. FIG. 28 is a schematic illustration of overview of data flow and operations in accordance with examples described herein. The data flow of a four-level 2D FMM with a single source point is located approximately in the center of the spatial domain. The three layers represent the function and its partial derivative in both spatial directions, for example, ρ=1 in this example. Level 1 is different from the original formulation of the FMM by approximating near-field interaction by a series expansion. Source locations may be sorted into their respective boxes (P2M) at the highest grid granularity. The computational graph then branches off: the M2L procedure may be applied to compute the L-expansion at the highest level, but at the same time the M-expansion at the next lower spatial resolution can be computed. This branching may allow for a large degree of parallelization. Computing the highest resolution L-expansion is the computationally demanding and may be done at the same time as the M2M, M2L, and L2L procedures at lower spatial resolutions.

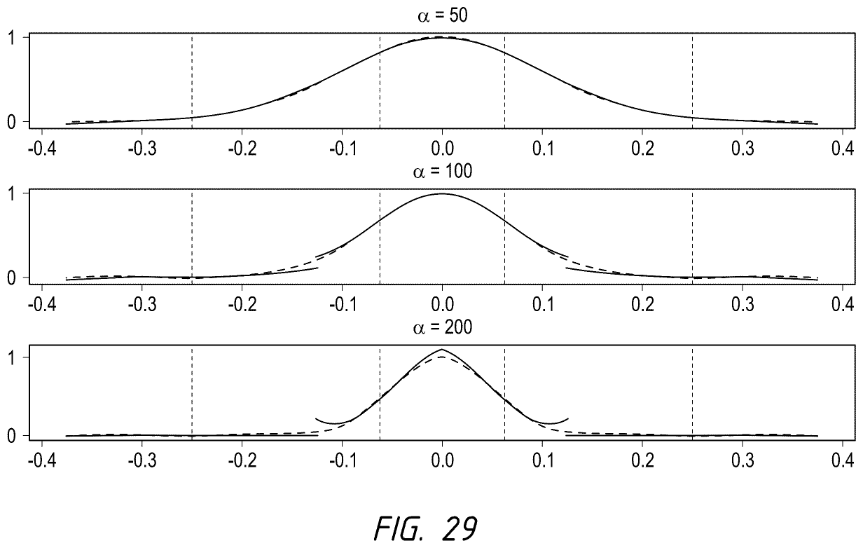

Unlike Fourier series, Taylor series may not expand a function into an orthogonal basis in the data limit, which may cause odd and undesirable behaviors. When ƒ(x)=exp(−ax) when a is much greater than 1, the nth derivative of ƒ is ∇ⁿƒ(x)=(−a)ⁿ exp(−ax). If a Taylor series expansion of ƒ were performed, the magnitude of derivatives increases exponentially while oscillating around the x-axis. The odd-ordered derivatives may overshoot toward −∞ while the even-ordered derivatives overshoot toward ∞. Furthermore, the series expansion may consider the desired radius of convergence and order of the expansion. Thus, ƒ may be expanded in a polynomial basis that is optimal in the least-squares sense for a given radius of convergence and expansion order. Regular polynomials may be fitted to the kernel and its partial derivatives. This technique may reduce a number of grid cells and ρ of the M2L kernel in comparison to the ordinary Taylor expansion for a similar degree of accuracy, and thus may improve memory and computational restrictions. Fitting polynomials to the kernel and its partial derivatives may be performed once in a pre-processing step. FIG. 29 is a schematic illustration of effects of a polynomial fitting to a kernel and its partial derivatives in accordance with examples described herein. The order of the expansion in this example is ρ=4 and the kernel is ϕ(x)=exp(−αx²) for various α. Top lines show the approximation with regular Taylor series while dark lower lines show the approximation by first performing a least-squares polynomial fit. Vertical dashed lines denote locations of expansions.

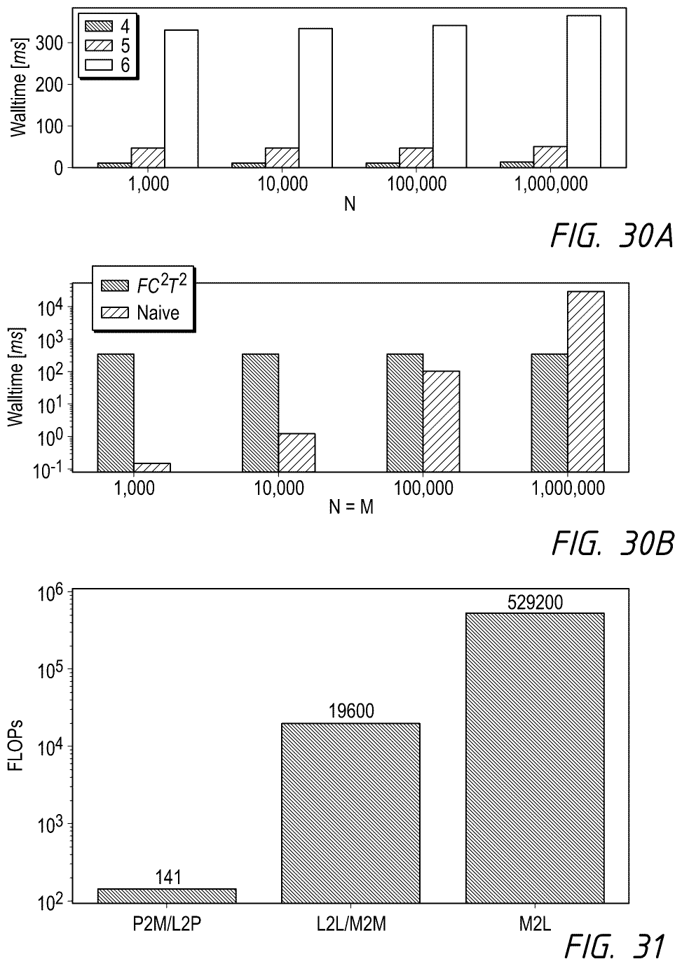

Examples of the FC2T2 expansion described herein were generally designed based on the principles of robustness, ease of use/implementation, and generality. Examples may be robust because their speed is independent of the distribution of source points and general because it allows for any symmetric kernel (ϕ(q, p)=ϕ(p, q)) whose radius of convergence increases exponentially with distance from center. If a specific kernel would be assumed, further speed-ups could be achieved by, for example, decomposing the M2L kernel for each spatial dimension for kernels that allow this like, for example, the Gaussian kernel or by using an adaptive instead of a fixed grid. FIGS. 30A-31 show performance benchmarks in accordance with examples described herein. The techniques scale linearly with batch and channel dimension and results are shown for B=C=1 and a Gaussian kernel ϕ(x, y, z)=exp(−α(x²+y²+z²)) for α depending on the number of levels because expansions on a finer grid (more levels) allow for smaller or tighter Gaussian kernels. In this benchmark test, a is constant (=four). FIGS. 30A and 30B show the effects of changing the granularity of the grid by varying the levels of the expansion and varying the number of source and target locations. A comparison of the wall time required for the expansion and extraction step for different levels of the expansion and number of source and target locations are shown. FIG. 30A shows wall time for expansion. The granularity of the grid as opposed to the number of source locations determines the majority of the run-time of the expansion. FIG. 30B shows wall time for expand and extract, showing a comparison between the naive implementation and the FC2T2 technique with grid granularity level 6 in log-scale assuming N=M. Even for a modest number of parameters and evaluations (N=M=1m) in the context of ML, FC2T2 is already approximately 75 times faster.

FIG. 31 is a schematic illustration showing a comparison of numbers of FLOPS in log-space used for each step of the FC2T2, under the assumption that the number of grid cells is approximately the same as N and M. The M2L uses the largest amount of computation by far.

Considering the applications in computer graphics and vision, 8m source locations were evaluated at approximately 10m target locations. In that case, the FC2T2 expansion was 10,000 times faster compared to its naive implementation. The memory consumption was fairly modest. A four-level, five-level, and six-level expansion used storage of 32×32×32×35 (4.5 MB), 64×64×64×35 (36.7 MB), and 128×128×128×35 (293.6 MB) values per channel respectively. The performance of the technique was analyzed. The technique was found to scale gracefully with N and M. The P2M and L2P kernels were found to be dependent on N or M respectively. Locating the box of a single source or target particle may be done by computing int((pᵢ+1)N/2) for each spatial dimension, therefore using 3 FLOPS per spatial dimension assuming that casting to an integer uses 1 FLOP and N=2 was precomputed. Then distances to the center of the box need to be computed which uses 1 FLOP per spatial dimension and p-many powers weighted by factorials are computed resulting in 8 FLOPS per spatial dimension. For each partial derivative of a certain order, 2 FLOPS are required to compute the product of distances and in case of L2P another FLOP to multiply with the respective coefficient and P−1 to sum weighted coefficients up. A 3D expansion with ρ=4 implies that P=35. This entails that for P2M and L2P a total of 9+3+24+35*2=106 FLOPS and 9+3+24+35*4=176 FLOPS per source and target location are needed respectively. The majority of the FLOPS is spent on work that is independent of N and M. Per grid cell, the M2L and L2L operations may take 35²×2³×2 FLOPS whereas M2L may take 35²×6³×2 FLOPS. This implies that M2L is the most expensive operation of the algorithm by a large margin when making the not unreasonable assumption that the number of grid cells is roughly on the order of M and N. Thus, in reality, the computational complexity of the FC2T2 expansion is in O(106N+176M+C) with a very large constant coefficient C that is mostly affected by the grid granularity level. This has direct implications on which types of problems are suitable for the FC2T2. In general, expanding source locations and weights can be seen as trading off memory for computation. In the case that a model would need to be served to millions of users, the respective expansion could just be kept in memory and potentially large performance gains could be achieved in comparison to, for example, neural networks. Even a modestly sized neural network may take over 1m FLOPS for a single evaluation. Thus, in a scenario where a single static model needs to serve a large number of requests, performance gains of 5,000 times may potentially be achieved in comparison to a modestly sized neural network. More generally, the FC2T2 expansion is suitable for problems that perform repeated evaluations. The FC2T2 may be useful in solving problems in graphics and vision that have this property.

Explicit and implicit layers referred in description of FIG. 8 provide operations that may use the series expansions in the context of gradient based learning, specifically deriving JVPs for the backpropagation for computational layers that could potentially be used within neural networks. The JVPs can be approximated by the FC2T2 expansion.

Examples of explicit Taylor layer operations are described herein.

In some examples, an explicit Taylor layer may be used. FIGS. 32A-32D show mathematical equations and/or approximations representing a process of obtaining explicit Taylor layer operations in accordance with examples described herein. The explicit Taylor layer may be a simple computational layer that internally uses the FC2T2 expansion described earlier. Output of the explicit Taylor layer may be represented by the equation of FIG. 32A. In the equation of FIG. 32A, y has the functional form for the FC2T2 and can therefore be approximated efficiently. In general, any combination of p, q, and/or w could be used as data, model parameters, or inputs from a previous computational layer. Some properties of the intermediate expansion may be exploited for additional reduction of processing time. In some examples, with an expansion recycling technique, a single expansion is used to evaluate ƒ(q1, p, w) and ƒ(q2, p, w). In general, if the arguments behind the semicolon of ƒ remain unchanged, the previously computed expansion can be recycled. In some examples, partial derivatives may be computed. If the computational cost for expanding p and w has been paid, ƒ as well as rƒ with lower precision may be evaluated efficiently at any location q.

When y̅∈ [symbol] ^{M} is a tangent vector (an incoming error propagated backwards from its subsequent layer) at which the JVP needs to be evaluated, then computationally efficient strategies to obtain quantities shown in FIG. 32B may be for the explicit layer to be used in the context of gradient based learning.

When a JVP may be brought into the functional form of ƒ, the JVP may be approximated using the FC2T2 expansion. Because of the simplicity of ƒ, deriving the JVPs is relatively easy as equations shown in FIG. 32C when a symmetric kernel meets ϕ(p, q)=ϕ(q, p).

For every iteration of the backpropagation technique, two expansions may to be computed. Because the gradients with regard to q involve an expansion for p and w, the expansion computed in the forward pass may be recycled. A second expansion may be performed for gradients with regard to p and w. In the forward pass, weights are inserted into the expansion at source locations to be evaluated at target locations, and during the backward pass, errors may be inserted into the expansion at target locations to be evaluated at source locations.

The explicit layer of the above may have various applications based on inputs that may be trainable parameters, data, and inputs from previous layers. Some applications may lie in computer vision and graphics. The explicit layer may be used to fit a signed distance function that is similar to the technique of DeepSDF but orders of magnitudes faster. Experiments are designed along with the applications.

### Experiment: Rank Constrained High Dimensional Linear Layer

When adopting the linear algebra view on the FMM technique, a linear layer can be devised that is similar to the regular convolutional layer or a low-rank layer. The regular convolutional layer is a sparse linear layer whose sparsity patterns are induced by the kernel shape. For example, if a kernel size of three is used, then the corresponding convolutional layer could be implemented as a sparse linear layer with three-element blocks on the diagonal in the case of a 1D convolution. This layer is low-rank. Similarly, a linear layer has a rank constrained in order to gain computational accelerations as the degenerate kernel example. Without non-linearities, such a layer may not be useful because the output of the layer would also be low-rank and therefore have redundant information. The non-linearity that typically follows a linear layer that is either low-rank or increases the output dimensionality inflates the rank of its outputs, as shown in FIG. 32D.

In general, given a suitable non-linearity σ, the rank of y₁ is always smaller or equal compared to the rank of y₂ if Wₗᵣ is low-rank. When choosing p and q as model parameters, the explicit layer could be used similarly. However, the non-linearity may be applied to the low-rank matrix before multiplying with the input x. Even though (Wₗᵣ) is full rank given a suitable kernel, the price for multiplying x and (Wₗᵣ) would be reduced significantly. Because such a layer is still linear in its inputs, in a multi-layer setting, a non-linearity may still be applied afterwards. However, a simple low-rank layer seemed to converge faster and to better solutions.

### Experiment: Compressed Sensing

When p and w are data and q is parameters, the explicit layer could potentially be used for compressed sensing or optimal sensor placement. A training set may include pairs of p and w describing a low-dimensional phenomenon of interest, such as concentrations of chemicals or pollutants in the atmosphere on a specific day. Since q determines spatial locations where the phenomenon is being measured, optimizing q may yield optimal measurement locations. The explicit layer would be used as the input layer and the output would be fed into a classifier. Such a layer would also be approximately twice as fast because no additional expansion is required for the backward step as q̅ uses information that can be extracted from the expansion of the forward pass.

### Experiment: Fitting a Signed Distance Function

In applications in computer vision and graphics, by choosing q to be data and p and w to be model parameters, the explicit layer may be used to fit a signed distance function. The value of an SDF may represent the shortest distance to the object. Thus, roots of the SDF may determine the surface of the object. As the name suggests, this distance function is signed and its negative values imply that a point is within an object. Fitting SDFs has a long history and fast solvers have been used; more recently, neural networks may model SDFs. The python package mesh_to_sdf³ may be used for sampling signed distance functions given a polygon mesh. In an experiment, 10m samples were generated from a triangle mesh describing a bust of Albert Einstein. Let \hat{q} denote the sample locations and [symbol] distances of the locations to the object. The mean absolute error was minimized with regard to p and w, for example, |ƒ(\hat{q},p,w) [symbol] |, and training was performed on all 10m points jointly. Alternatively, to use neural network nomenclature, a batch size of 10m was used. One epoch takes between 130 ms and 1.2s depending on the level of the expansion. A Gaussian kernel ϕ(x, y, z)=exp(−α(x²+y²+z²)) with varying α depending on expansion level was used.

FIGS. 33A-33C illustrate visual comparisons of results using the explicit Taylor layer operations for SDF in accordance with examples described herein. FIG. 33A is obtained under the conditions of grid granularity level 4, N=8m, M=10m, α=200, trained for 1,400 epochs for approximately 3 min (130 ms/epoch) to an average mean absolute error (MAE) of 10.6E-4. FIG. 33B is obtained under the conditions of grid granularity level 6, N=8m, M=10m, α=4,000, trained for 1,000 epochs for approximately 20 min (1200 ms/epoch) to an average MAE of 5.6E-4. FIG. 33C shows a result of fitting a neural network trained to an MAE comparable to FIG. 33B in approximately 5.5 hours (1,333 epochs of 13s each).

For a granularity level of 4 as shown in FIG. 33A, the general shape of the object can be discerned but most details are missing. At a granularity level of 6, fine details such as eye lids, wrinkles, and facial hair are resolved much better. The results of SDF fitting were compared with the neural network result of FIG. 33C. With a batch size of 16,384 one epoch takes approximately 13s. Thus, the explicit layer based on FC2T2 is approximately 10 times faster with a suboptimal implementation of the M2L subroutine. Training the neural network for one epoch took 36,741.12G FLOPS while the explicit layer with granularity level 6 took 1.17 G FLOPS (and 154 GFLOPS for separable kernels) therefore resulting in a 28 times reduction (and 237 times reduction for separable kernels) in FLOPS. The technique optimizes models that have different inductive biases from neural network; however, the bias of the explicit layer may be desirable in the context of vision and graphics. Neural networks tend to struggle to learn high frequency variations and tend to learn approximations with a low norm in function space, which may be less desirable in the context. If p and w were initialized uniformly random between (−1, 1), the output of the explicit layer may fluctuate rapidly. The explicit layer seems to learn high frequency features quickly. When the learning procedure is terminated prematurely, the resulting rendering seems to exhibit holes in Einstein's face. This suggests that low frequency information is corrupted as opposed to a premature rendering of the neural network approach that exhibits closed surfaces regardless of lacking fine details.

Examples of root-implicit Taylor layer operations are described herein.

In some examples, a root-implicit Taylor layer may be used. A root-implicit Taylor layer has an output that is implicitly defined. For example, the layer outputs quantities related to the root of a function along a line or, to use graphics/vision nomenclature, a ray. When r, o∈ [symbol] ³ are direction and position vectors respectively, o may be understood as the position of a pinhole camera and r as a viewing direction. For many applications, there may be multiple r, usually one for each pixel in a 2D image. In the following derivations, a single r is assumed; however, its generalization is trivial. Similar to the application of the explicit layer to model SDFs, a function ƒ whose roots define the surface of a 3D object may be assumed. The root-implicit layer can be used to output any combination of two quantities related to roots of ƒ. First, the distance between the position of the pinhole camera o and the object along the ray may be defined as a ray length yₗ, and second, a surface gradient y∇ (a scalar-multiple of the surface normal) at the root may be defined. FIG. 34 shows mathematical equations representing parameters in a root-implicit Taylor layer in accordance with examples described herein. The parameters of FIG. 34 may be used for many rendering tasks.

Examples of systems and methods described herein may be utilized in root finding procedures.

Before deriving the JVP of the root-implicit layers, a fast algorithm that allows for the extraction of roots along a ray may be introduced that acts directly on the intermediate Taylor representation of ƒ. This technique does not assume ƒ to be a proper SDF where function values contain exact information about the distance to a root. The intermediate representation of the FC2T2 expansion outputs a grid whose cells contain a 3D Taylor series expansion at its center. Because the expansion is in 3D, a cell on the grid may be referred to as a box or voxel. The technique finds a first root along a ray by enumerating the boxes that are intersected by the ray.

FIGS. 35A and 35B are schematic illustrations of a root-implicit Taylor layer in accordance with examples described herein. The root finding technique may intersect a ray with boxes and then convert 3D Taylor expansions into univariate polynomials for which analytic solutions exist assuming an order less than or equal to 4.

In FIG. 35A, in order to find a root along a ray from o in the direction r all boxes that intersect the ray are extracted. A 1D polynomial of order ρ is then extracted and checked for a root. The graphic illustrates an example in 2D. Any line through a 3D Taylor expansion can be converted to a univariate polynomial of the same order. Furthermore, for orders less than or equal to 4, analytic closed-form solutions for the roots exist. The conversion of a line through a 3D Taylor expansion to a 1D polynomial may be used.

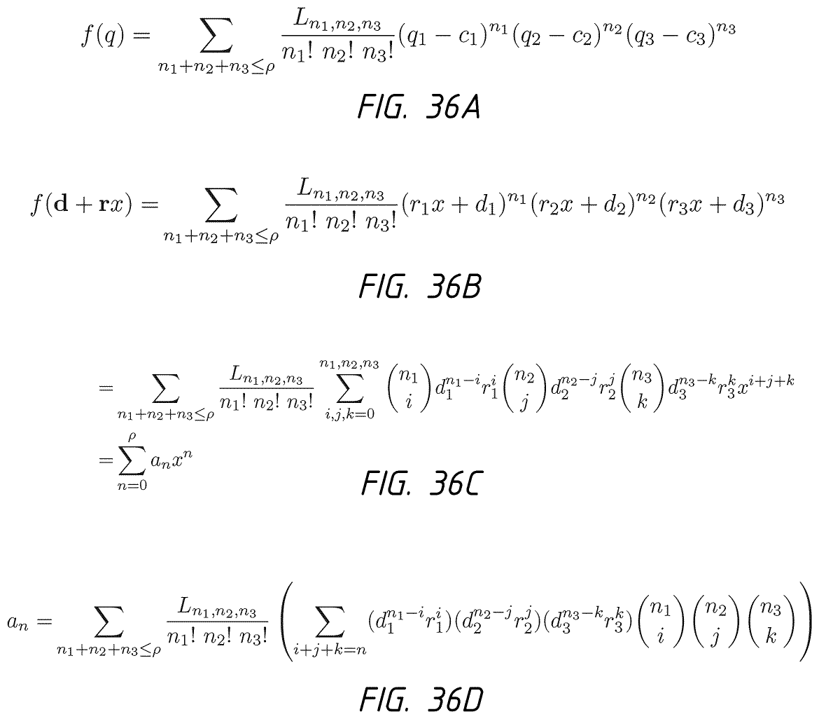

FIGS. 36A-36D show mathematical equations representing a process of root finding accordance with examples described herein. As described earlier, the intermediate representation of the FC2T2 approximates a function globally with a series of local 3D Taylor expansions distributed on a grid. Every 3D Taylor expansion stores partial derivatives up to a certain order evaluated at the center of the cell. When L_{n1,n2,n3} be the coefficient representing ∂^{n1,n2,n3}ƒ and c the center of the box, the equation of FIG. 36A may be obtained.

In FIG. 35B, any ray through a box representing a 3D Taylor series expansion may be converted to a 1D polynomial of order ρ. For 1D polynomials of order ρ≤4 analytic and fast solutions for roots are available.

When the ray o+rx intersects with the box at location d in the coordinate frame of the box (center of box is origin) as shown in FIG. 35B, the equation of FIG. 36A may be further rewritten as FIG. 36B. By using the binomial theorem, the equation of FIG. 36C may be derived, where aₙ is represented by the equation of FIG. 36D.

For ρ=4, a naive implementation of this operation may take 1,465 FLOPS. When applying SymPy's common subexpression elimination, the computational costs can be reduced to 668 FLOPS.

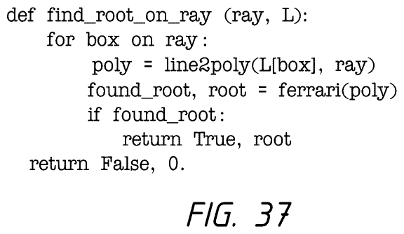

FIG. 37 shows a pseudo code representing a process of root finding in accordance with examples described herein. Fast root finding on ray technique may be summarized in the pseudo code of FIG. 37. Any ray through an N×N×N grid intersects with at most 3N boxes. In the worst case scenario, for example, when no root was found, the root finding procedure may take 3N(668+136)FLOPS per ray. For a grid granularity level of 6 (128×128×128 boxes), this is equal to 308,736 FLOPs. Once the price for the expansion has been paid, finding a root along a ray requires about 10 times less FLOPS than a single evaluation of the neural network.

### [Jacobian Vector Product]

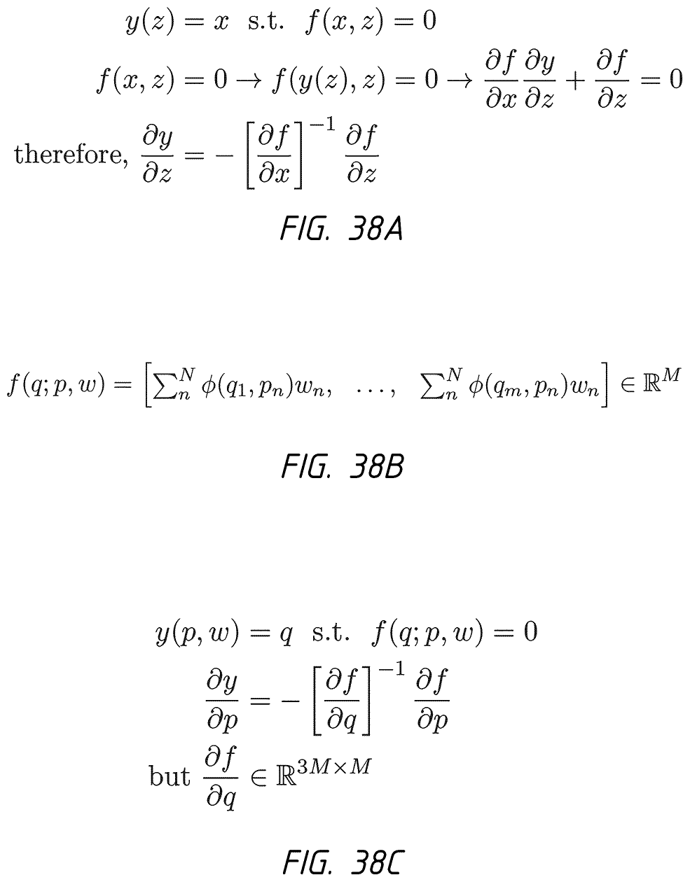

FIGS. 38A-38C show mathematical equations representing a process of JVP in accordance with examples described herein. The root finding JVPs used for gradient based learning will be described. Because the output of the layer is defined implicitly, the Implicit Function (or Dini's) Theorem (IFT) may be used. Under mild conditions, the IFT may be represented by the equation of FIG. 38A. This derivation reveals some of the conditions for the IFT to apply, for example, that ∂ƒ/∂x be invertible.

When ƒ is the functional form, its evaluation can be accelerated by a variant of the FMM as shown in FIG. 38B.

The IFT does not hold for arbitrary roots of ƒ because of the relationship shown in FIG. 38C. The ∂ƒ/∂x is not invertible because it is underdetermined. However, invertibility may be ensured by assuming that the root lays on a ray.

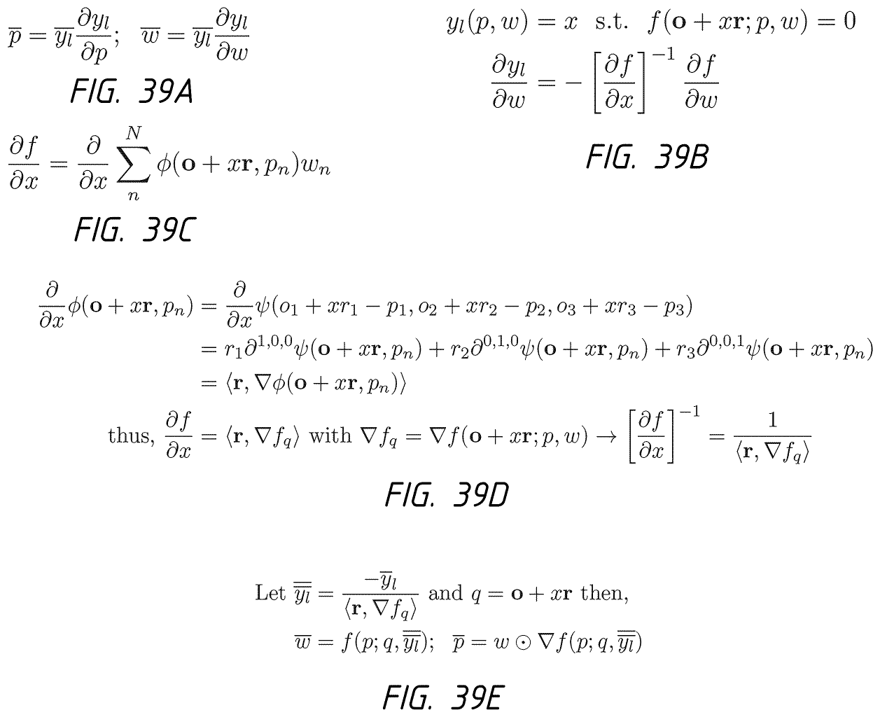

Ray length JVP may be introduced. FIGS. 39A-39E show mathematical equations representing a process of ray length JVP in accordance with examples described herein.

When yₗ(p,w)=x subject to ƒ(o+xr; p,w)=0 and y̅∈ [symbol] ^{M} is the tangent vector (the incoming error propagated backwards from the subsequent layer), then the JVPs of FIG. 39A may be derived for gradient based learning.

In the equation of FIG. 39B, the JVP with regard to w is derived. The JVP with regard to p is analogous and obtained similarly.

The ∂ƒ/∂w has been previously derived. Furthermore, [∂ƒ/∂x]⁻¹ may be used. FIG. 39C shows an equation to obtain ∂ƒ/∂x.

Using the assumption that ϕ(p, q)=ψ(p₁−q₁, p₂−q₂, p₃−q₃), the equation of FIG. 39D may be derived.

While the derivations assume a single ray, most practical applications include hundreds of thousands of rays. However, because there is no “cross-talk” between rays, the derivations remain unchanged when multiple rays are assumed. The FC2T2 expansion can be employed to approximate the JVP as shown in FIG. 39E. Here, ∇ƒ_{q} may be computed from the expansion of the forward pass.

Thus, the JVP may be obtained using the FC2T2 expansion and projecting the gradients according to the IFT comes at almost no additional cost in comparison to the explicit layer since ∇ƒ_{q} can be computed from the forward-pass expansion.

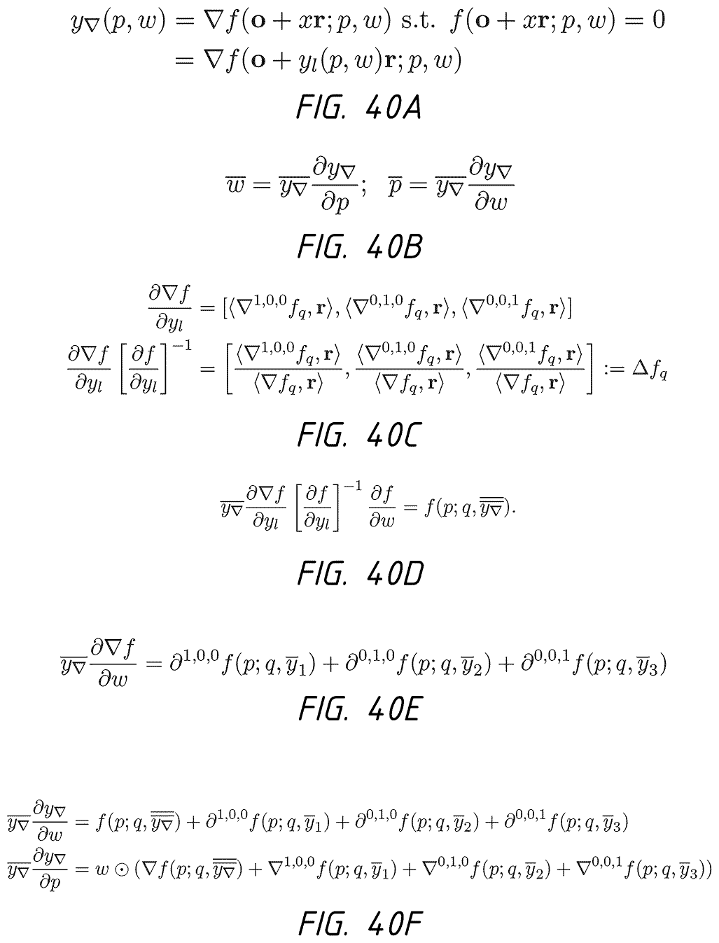

Surface gradient JVP may be introduced. FIGS. 40A-40F show mathematical equations representing a process of surface gradient JVP in accordance with examples described herein.

For many applications in vision and graphics such as, for example, inverse rendering, knowledge about surface normals is paramount. Surface normals may play an important role in many shading models. As the name suggests, surface normals represent the gradient at the surface of an object normalized to unit length. In the following, the JVPs for updating model parameters based on surface gradients are introduced. The surface gradient may be derived instead of normal JVP mostly for convenience and the fact that the normalization can be performed in auto-differentiation frameworks. Like the previous layer, the surface of an object is encoded as the root of a function ƒ, however, instead of outputting the distance between o and the object, the surface gradient is returned as shown in FIG. 40A.

The JVPs of FIG. 40B may also be derived similarly for gradient based learning.

The JVP with regard to w may be derived because the JVP with regard to p is analogous. The chain rule of derivatives may be applied. The quantities that have not been derived previously are ∂∇ƒ/∂yₗ and ∂∇ƒ/∂w. Thus, the equation of FIG. 40C may be derived.

Note that y̅∇̅∈ [symbol] ³ and y̅∇̅=<Δƒ_{q}, −y̅∇̅ entail the equation of FIG. 40D. For the remaining quantity to be derived the following holds a relationship represented by the equation of FIG. 40E.

As a conclusion, equations in FIG. 40F may be obtained. Thus, computing the JVPs for the surface gradients uses two expansions for the backward pass: one projection expansion and one three-channel gradient expansion. The backward pass is therefore slower in comparison to the explicit and ray-length layer introduced earlier but still reasonably fast.

Four potential applications of the root-implicit layer as experiments will be exhibited. The objective of the first two applications is to extract a 3D representation from depth information. The third application combines the explicit and root-implicit layer to model RGBD images while the last application makes use of the surface normal gradients in the context of inverse rendering.

### Experiment: Learning a Depth Field

A coherent 3D representation may be obtained from images collected with a depth camera. This application is based on a data set collected by a vertically mounted depth sensor (Microsoft Kinect) above a classroom door intended to improve building energy efficiency and occupant comfort by estimating occupancy patterns. The goal this application is to extract coherent 3D representations given noisy depth information. The depth field collected by the camera is normalized to fit into the domain of the expansion, i.e. (−1; 1). The output of a depth camera measures the distance to objects in the field of view and is therefore amenable to the root-implicit layer that outputs ray length. Because the data is fairly low in resolution, a level 5 expansion with a Gaussian kernel (=1,000) is chosen and the mean absolute error for 300 iterations was minimized to an average error of approximately 0.5%. One iteration takes approximately 250 ms implying a total training time of 75s per image. Special attention needs to be given to the initialization of p and w. If the root finding algorithm is unable to locate a root within the domain or if ƒ is negative at the first intersection of the domain and ray, the output of the layer and therefore its gradient for the corresponding pixel is undefined. In order to avoid “dead pixels,” p and w may be initialized in such a way that every ray has a proper root within the domain. For example, a bias term may be introduced, and w may be initialized to be relatively small. Furthermore, in order to suppress artifacts, w may be additionally regularized.

### Experiment: Learning to Learn a Depth Field

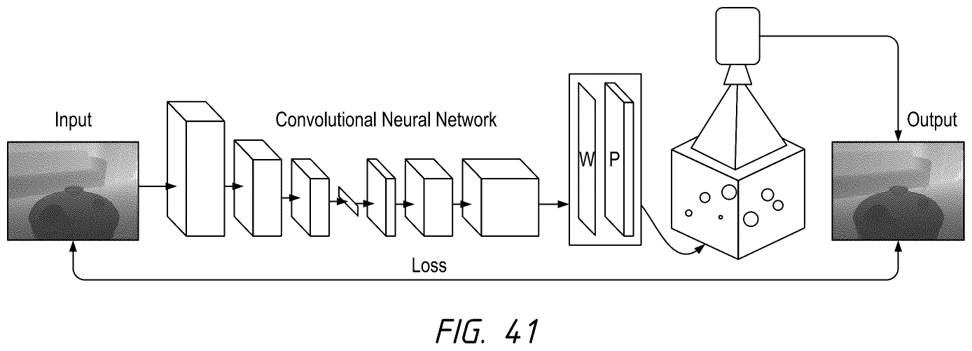

The learning a depth application demonstrated the ability of the FC2T2 technique to model the real world and noisy depth data. However, processing a single frame took more than 1 minute, which may be too slow for any real-time application. In this application, a neural network with inferring optimal p and w that induce a given depth field may also be used. The neural network is trained in an autoencoder fashion, for example, it is presented with the desired depth field, and produces parameters p and w which are fed into the depth layer. FIG. 41 shows a schematic illustration of an autoencoder in accordance with examples described herein. The encoder employs the FC2T2 depth layer as its decoder. A regular convolutional neural network is tasked with predicting the optimal p and w. The mean absolute error between the desired depth and the output of the depth field may be minimized. Because the neural network is tasked with predicting the parameters of another module, the application may be considered as an operator. Processing a single frame, for example, forward and backward pass including the Convoluted Neural Network (CNN), takes approximately 800-900 ms, and once the CNN is trained, rendering a single frame, e.g., a forward pass of the CNN followed by expansion and rendering, takes approximately 400-450 ms. The average MAE is 4% and 5.6% on training and test set, respectively. Employing the neural network to predict optimal p and w′ that induce a given depth field therefore results in an average acceleration of approximately 190 times at the cost of increasing the error about nine-fold.

### Experiment: Sensor Fusion: RGBD

In this application, an explicit and depth layer were combined to represent images collected with RGBD cameras. A single frame collected for the dataset was used for an experimental purpose. The dataset contains depth and color information. Depth data is modeled with the proposed depth layer, and the explicit layer introduced earlier may be used to model color. For example, the combined layer outputs depth and color at the root. Training on a single frame takes approximately 2.5 min from scratch but could potentially be sped up by a neural network in a similar fashion as described in the previous experiment. FIG. 42 illustrates visual comparison of results using operations for RGBD layer in accordance with examples described herein. The top left image shows the ground truth color (RGB) data. To the right of the ground truth is the output of the RGBD layer from the same viewpoint as the ground truth. The two frames at the bottom show renderings from novel viewpoints.

### Experiment: Inverse Rendering

Another application may be inverse rendering. Data from “Reconstruction Meets Recognition Challenge 2014” was used for an experimental purpose. The data set contains ground truth measurements of surface normals extracted from RGBD data collected with a Microsoft Kinect sensor. The surface normals were rendered by assuming a single light source and no color, for example, the resulting image contains a single value per pixel that includes the dot product of the surface normal and the imaginary light source. Because the layer outputs surface gradients as opposed to normals, the output is first normalized before it is dot-multiplied by a free parameter describing a light source. The mean absolute error for 10,000 epochs over the entire image of resolution 420×560 may be minimized. Because the image does not contain much detail, a grid granularity level of 5 may be chosen with a Gaussian kernel (=1,000). A single epoch takes approximately 600 ms which entails a total training time of approximately 100 min. Even though a single epoch is reasonably fast, the model was found to converge slowly to a solution with limited but reasonable accuracy with an average error of 2.6%.

### Integral-Implicit Taylor Layer Operations

In some examples, integral-implicit layers may be used, and strategies to approximate the JVPs required for gradient based learning are derived. The layer outputs line integrals along a ray, for example, similar to the root-implicit layer, when o and r are a position and direction vector that encode the position and a viewing direction of a pinhole camera respectively. One of the fast techniques that allow for the analytic computation of integrals along rays that act directly on the intermediate Taylor representation will be described.

### [Line Integration]

A simple integral represented by the equation of FIG. 43 may be developed.

Analogously to the root finding technique, iteration over all boxes that the ray intersects with may be performed, and the ray may be converted through the box to a univariate polynomial as described in FIGS. 35A and 35B. The function along the ray may be a piece-wise polynomial and its integral can be computed by splitting the integral at ray-box intersections, i.e., ∫ₐ^{b}ƒ(x)dx=∫ₐⁿƒ(x)dx+∫ₙ^{b}ƒ(x)dx. FIG. 4 shows a pseudo code how a simple line integral can be computed along a ray, when a function intersect that returns two scalars x1 and x2 such that o+x1r and o+x2r describe ray-box intersection points.

Similarly to the root-implicit layer, computing the output of the forward pass does not use the L2P procedure and the FLOPs for the polynomial arithmetic are minimal. Assuming ρ=4, integrations take 5 FLOPS and evaluating the integral takes 17 FLOPS per box.

Recently, volumetric rendering has experienced a resurgence in popularity due to the success of neural radiance fields (NeRF). The volumetric rendering equation is a specific type of line integral defined by equations of FIG. 45.

In this case, σ(x) and c(x) describe particle density and particle color at a specific spatial location. T(x) can be interpreted as the probability that the ray has not yet hit a particle. For most rays, T(x) decreases monotonically to 0 and ensures that the camera cannot see past objects or through dense fog. Traditionally volumetric rendering was employed to render effects like fog, smoke, or steam. Currently, volumetric rendering may also be used to render solid objects for which σ(x) increases sharply at object surfaces. One of the challenges of computing the volumetric rendering integral is the T(x) term as there is no analytic (and therefore fast) solution to exp[−ƒ(x)] when ƒ(x) is a polynomial. This difficulty may be alleviated by approximating exp[−x] for 0≤ x≤5 by a polynomial and assume that exp[−x]=0 for x>5.

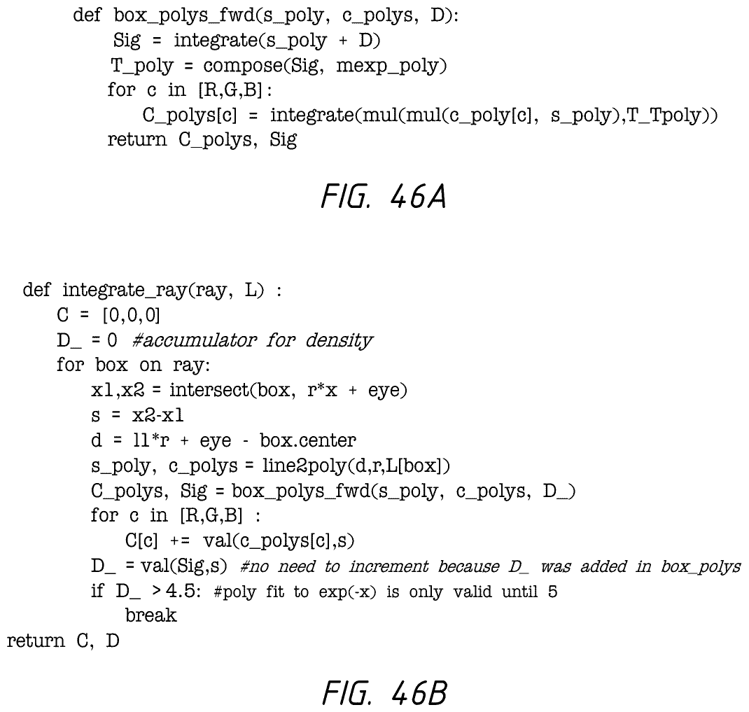

FIGS. 46A and 46B show pseudo codes representing processes of volumetric rendering integral in accordance with examples described herein. “mexp_poly” may be used as the coefficients of this polynomial approximation of order 4. The pseudo code of FIG. 46A shows how the volumetric rendering integral can be computed without numerical integration based on the FC2T2 expansion.

When s_poly and c_poly are set to the polynomials describing σ(x) and c(x) respectively, then the volumetric rendering integral may be computed as shown in FIG. 46B.

### [Jacobian Vector Product]

In the context of gradient based learning, the technique to evaluate the forward pass of a computational layer that outputs integrals along rays has been described. JVPs may be computed using the FC2T2 expansion. Computing the JVPs may not use the P2M procedure, for example, at no point are particles inserted into the expansion.

### [Line Integral JVP]

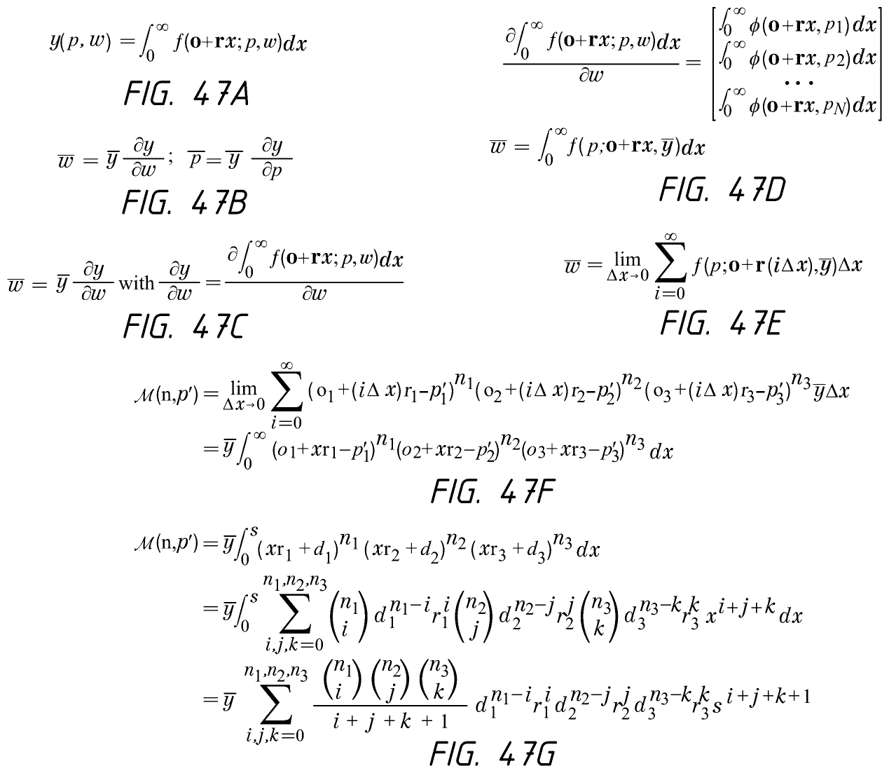

FIGS. 47A-47G show mathematical equations representing a process of line integral JVP in accordance with examples described herein. The JVP for the simple line integral may be represented by the equation of FIG. 47A.

For the backward pass, the JVPs in FIG. 47B may be approximated.

Because p̅ is analogous, w̅ may be used as shown in the equation of FIG. 47C.

Expanding the Jacobian above, the relationships described in equations of FIG. 47D may be obtained.

However, the resulting expression for w seems problematic because the integration variable appears behind the semicolon of ƒ, for example, it acts on quantities for computing the expansion. To evaluate the integral, it may be rewritten as a summation of FIG. 47E. The expression of FIG. 47E shows infinitely many expansions may be computed where for each expansion a single point would be inserted at location o+r(iΔx) with weight y̅. x may be incremented infinitesimally from expansion to expansion. While computing expansions is computationally expensive, Taylor expansions are additive and the infinitely many expansions may be collected into one. Instead of inserting a single point, infinitely many points may be inserted along a ray, for example, an entire ray may be inserted into the M-expansion.

Instead of the regular P2M-step, inserting infinitely many points along a ray into an infinitely wide box with weight y may be performed by the equation of FIG. 47F.

Applying the binomial theorem and assuming that the first intersection of ray and box is located at d and the length of the ray segment is s, the equation of FIG. 47G may be derived. The resulting M-expansion can be transformed into an L-expansion with the regular machinery described earlier. Thus, obtaining p and w remains unchanged as other JVP solutions described earlier.

### [Volumetric Rendering JVP]

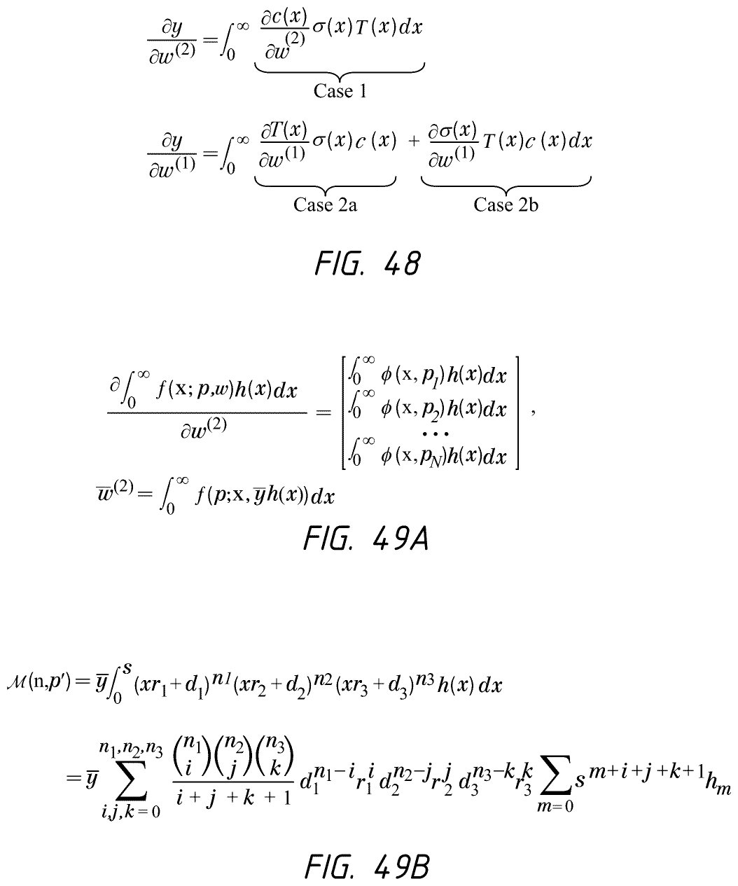

Deriving the JVPs for the volumetric rendering integral follows a similar strategy. FIGS. 48-50E show mathematical equations representing a process of volumetric rendering JVP in accordance with examples described herein.

By application of the chain rule, the Jacobians for volumetric rendering can be derived as the equation of FIG. 48.

As shorthand, x=o+xr and x′ may be defined analogously.

Case 1 in equation (3) of FIG. 48 may represent computing ∫₀^{∞}ƒ(x;p,w)h(x)dx. Using the entire ray inserted into the M-expansion, expanding the Jacobian, equations of FIG. 49A may be obtained.

The integration variable x appears in both arguments behind the semicolon. As long as h(x) is a polynomial (or may quickly be approximated by one), computing the JVP may marginally be more difficult. Instead of inserting infinitely many points with a fixed value y̅ into the expansion, this value is weighted by h(x) for x along the ray. Thus, h(x)=Σₘ₌₀hₘx^{m}. The quantity to be inserted may be derived as the equation of FIG. 49B.

Case 2 in equation (4) of FIG. 48 may contain Case 2a and Case 2b.

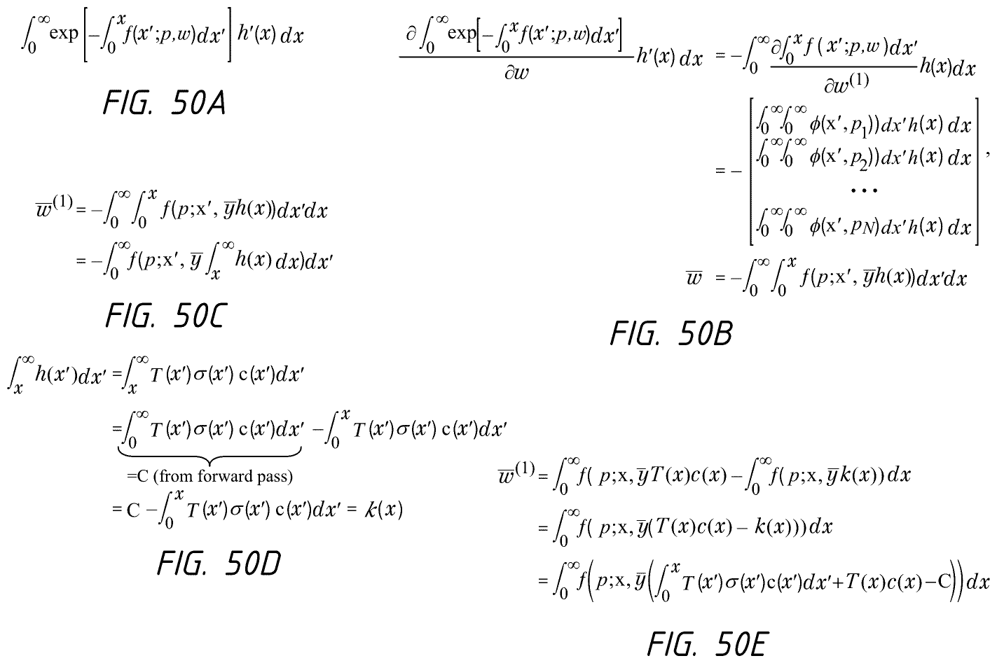

Case 2a corresponds to the case of computing the Jacobian with regard to the equation of FIG. 50A.

When h(x)=T(x)h′(x), then the equation of FIG. 50B may be obtained.

With a few simple manipulations, a double integral of FIG. 50B may be brought into the form of Case 1 and can therefore be solved similarly. For example, the order of integration may be altered as an equation shown in FIG. 50C.

Expanding h(x) may yield the equation of FIG. 50D.

Swapping the integration direction from x->∞ to 0->x avoids computing an acausal quantity, for example, a quantity that requires knowledge of the “future” of the ray. Combining this with Case 2b yields the equation of FIG. 50E.

In contrast to the Case 1, in order to solve Case 2, a ray-integral is inserted into the M-expansion for the backward pass. In order to perform the backward pass, a problem of similar difficulty as the forward pass may be solved. This is in contrast to the root-implicit layers having backward pass with a simple projection step.

### Experiment: Radiance Fields

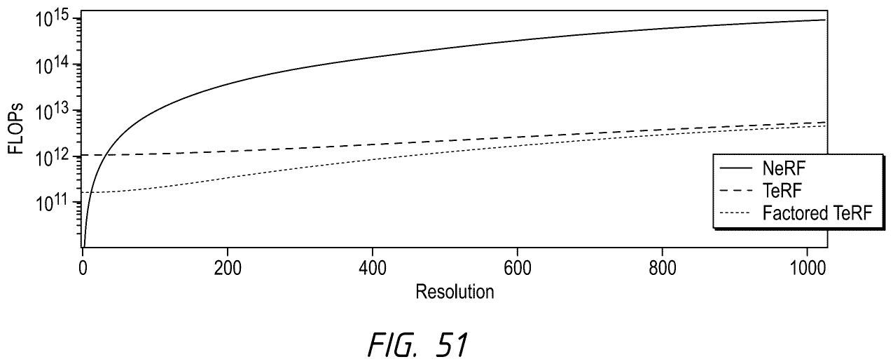

Radiance fields experiment uses knowledge of a data set that contains tuples of RGB images and poses (a tuple of pinhole camera location and viewing direction). Using this technique, a 3D representation of the object given this data set may be obtained. NeRF technique, resembling the DeepSDF network, may be trained by solving the volumetric rendering integrals numerically which results in many (usually 128) neural network evaluations per ray. Heuristics to encourage higher spatial frequencies and to reduce the FLOPs may be used for integration. The NeRF technique to the integral-implicit layer using Taylor expansion (TeRF). TeRF may evaluate the integral analytically instead of numerically but is still approximate in nature as it uses the FC2T2 procedure internally. TeRF dramatically reduces the FLOPS for the forward and backward pass. Assuming 128 evaluations per ray, the NeRF technique took approximately 300T FLOPS per pass so approximately 600T FLOPs in total. This entails 45 times or 157 times reduction in FLOPS depending on whether the kernel may be factorized. FIG. 51 illustrates a comparison of computation for the forward and backward pass as a function of the image's resolution in accordance with one embodiment. FIG. 51 compares NeRF and TeRF with regard to FLOPS for varying image resolutions. The comparison of the FLOPS used for the forward and backward pass as a function of the image's resolution is illustrated in FIG. 51. An intercept for TeRF is non-zero because of the FLOPS for the expansion. The non-factored TeRF breaks even with NeRF at a resolution of 34×34 or approximately 1,000 rays.

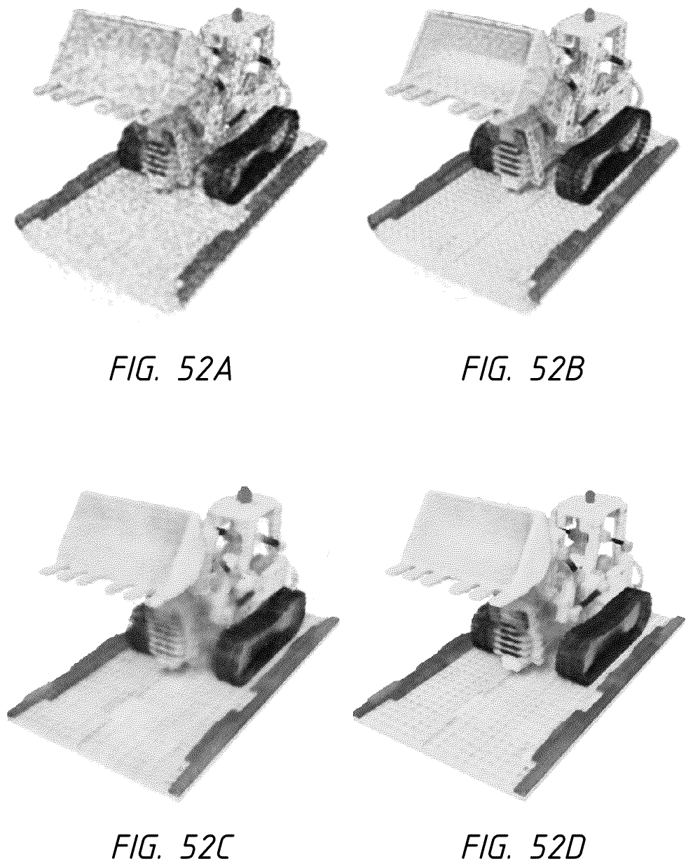

NeRF produces high quality images but requires multiple hours of training. FIGS. 52A-52D illustrate visual comparison of training results in accordance with examples described herein. In FIGS. 52A-52D, the output images of NeRF and TeRF were compared after 10 and 20 minutes of training respectively, for example, long before NeRF has converged.

FIG. 52A shows an image of TeRF at 10 min, MSE of 0.0101: The image looks overly “blotchy.” The overall shape is clearly visible and some detail is present. FIG. 52B shows an image of TeRF at 20 min, MSE of 0.0087: The image looks less “blotchy” and some high frequency details are clearly visible as, for example, holes in the Lego pieces. FIG. 52C shows an image of NeRF at 10 min, MSE of 0.012: The image looks blurry, but the overall shape is clearly visible. Some high frequency details seem visible. FIG. 52D shows an image of NeRF at 20 min, MSE of 0.009: The image looks less blurry and more high frequency details seem visible. Details like holes in the Lego pieces seem missing. Overall, NeRF seems to show a bias toward smooth or blurriness whereas TeRF seems biased toward “blotchyness” or high frequency noise. TeRF seems to have learned more high frequency details at the end of training.

Because of the slow run-time of TeRF's backward pass, 100,000 rays per iteration (or per expansion) were processed. TeRF is approximately four times faster in processing 100,000 rays; however, this does not result in a four times reduction in wall time. In general, TeRF converges quickly but to a significantly worse solution compared to NeRF. Even though not significant, TeRF seems to converge quicker in the beginning but levels out quickly. TeRF was trained with a level 6 expansion and 8m source points. However, after training only 2.35 out of the 8m source locations are associated with a non-negative density. Thus only about 35% of the source points contribute to the spatial density distribution.

Accordingly, methods of rendering an image including performing a convolution of a kernel function located at each of a plurality of source locations and weighted by input weights; storing, as a result of the convolution, for each voxel in a 3D space, coefficients of a series expansion; calculating line integrals along a ray in the 3D space using the coefficients of the series expansion in voxels along at least a portion of the ray; and rendering the image based, at least in part, on the line integrals may be provided in accordance with examples described herein. Accordingly, computational complexity may be reduced and processing time may be shortened by approximation using the convolution and series expansions. For example, images of an object from multiple locations may be rendered in a relatively short time, consuming less computation resources. In another example, a physical property in 3D space may be calculated in a relatively short time, consuming less computation resources. In this manner, computer visions and graphics or some type of 3D position-related physical property estimation may be achieved.

From the foregoing it will be appreciated that, although specific embodiments of the disclosure have been described herein for purposes of illustration, various modifications may be made without deviating from the spirit and scope of the disclosure.

The particulars shown herein are by way of example and for purposes of illustrative discussion of the preferred embodiments of the present disclosure.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments, or processes described herein may be combined with one or more other examples, embodiments, and/or processes or be separated and/or performed among separate devices or device portions in accordance with the present systems, devices, and methods.

Finally, the above discussion is intended to be merely illustrative of the present method, system, device, and computer-readable medium and should not be construed as limiting the appended claims to any particular embodiment or group of embodiments. Thus, while the present method, system, device, and computer-readable medium have been described in particular detail with reference to exemplary embodiments, it should also be appreciated that numerous modifications and alternative embodiments may be devised by those having ordinary skill in the art without departing from the broader and intended spirit and scope of the present method, system, device, and computer-readable medium as set forth in the claims that follow. Accordingly, the specification and drawings are to be regarded in an illustrative manner and are not intended to limit the scope of the appended claims.

What is claimed is:

1. A method of rendering an image, the method comprising:
performing a convolution of a kernel function located at each of a plurality of source locations and weighted by input weights;
storing, as a result of the convolution, for each voxel in a three dimensional (3D) space, coefficients of a series expansion;
calculating line integrals along a ray in the 3D space using the coefficients of the series expansion in voxels along at least a portion of the ray; and
rendering the image based, at least in part, on the line integrals.

2. The method of claim 1, wherein the performing the convolution is based on one or more images of an object in the image.

3. The method of claim 1, further comprising:
providing an array configured to allow a process to query function values and partial derivatives of the functions of the kernel function.

4. The method of claim 3, wherein the array includes one or more spatial dimensions configured to allow a process to query data of the image at continuous locations.

5. The method of claim 4, further comprising forming a meshgrid of individual inputs to the one or more spatial dimensions of a volume of the data.

6. The method of claim 1, further comprising:
finding a root along the ray intersecting the voxels; and
converting 3D Taylor expansions represented by the voxels into univariate polynomials.

7. The method of claim 6, further comprising:
providing a surface gradient that is a scalar-multiple of a surface normal at each root, wherein the roots are configured to define a surface of the object.

8. The method of claim 7, further comprising:
extracting a coherent 3D representation from images collected with a depth camera, said extracting comprising:
collecting, using the depth camera, a distance to at least one object; and
normalizing the distance to fit into a domain of the expansion.

9. A method of calculating a physical property in three dimensional (3D) space, the method comprising:
performing a convolution of a kernel function located at each of a plurality of source locations and weighted by input weights;
storing, as a result of the convolution, for each voxel in a 3D space, coefficients of a series expansion;
evaluating the physical property in the 3D space using the coefficients of the series expansion in voxels along at least a portion of a ray; and
estimating a value of the physical property at a particular position in the 3D space based on the evaluating.

10. The method of claim 9, further comprising controlling an order of the series expansion based on computer resource usage.

11. The method of claim 9, further comprising:
providing an array configured to allow a process to query function values and partial derivatives of the functions of the kernel function.

12. The method of claim 9, wherein the performing the convolution of the kernel function comprises:
generating a local representation based on series expansion for each voxel; and
computing values of the function.

13. The method of claim 12, further comprising controlling a size of each voxel.

14. The method of claim 9, further comprising:
finding model parameters of a neural network based on each of each of the plurality of source locations, the kernel function thereof, and the weight thereof; and
providing the model parameters as feedback inputs.

15. The method of claim 14, further comprising generating the kernel function by machine learning.

16. The method of claim 14, further comprising:
approximating Jacobian Vector Product (JVP) using a fast continuous convolutional Taylor transform (FC2T2) expansion; and
providing the JVP for backpropagation in the neural network.

17. The method of claim 9, further comprising extracting gradients and partial derivatives of order 2.

18. The method of claim 17, wherein the gradients and the partial derivatives are in a volume.

19. The method of claim 9, further comprising:
finding a root along the ray intersecting the voxels; and
converting 3D Taylor expansions represented by the voxels into univariate polynomials.

20. The method of claim 19, further comprising:
providing a surface gradient that is a scalar-multiple of a surface normal at each root, wherein the roots are configured to define a surface of the object.

21. The method of claim 9, further comprising:
converting 3D Taylor expansions represented by the voxels intersected by the ray into univariate polynomials; and
computing integrals by splitting the integrals at intersections of the ray and voxels.

22. The method of claim 21, further comprising:
training a neural network by computing the integrals numerically to provide many neural network evaluations per ray.
